(19) United States
(12) Patent Application Publication
(10) Pub. No.: US 2026/0219740 A1
(43) Pub. Date: Jul. 30, 2026

(54) ABBREVIATED HANDWRITING TECHNIQUE FOR TEXT INPUT

(71) Applicant: Google LLC, Mountain View, CA (US)

(72) Inventors: Shumin Zhai, Los Altos, CA (US); Zheer Xu, West Lebanon, NH (US); Shanqing Cai, Cambridge, MA (US)

(21) Appl. No.: 19/143,159

(22) PCT Filed: Dec. 29, 2022
(86) PCT No.: PCT/US2022/082578

§ 371 Date: Jun. 25, 2025

(51) Int. Cl. G06F 3/023; G06F 3/04883; G06F 40/274

(52) U.S. Cl. CPC G06F 3/0237; G06F 3/04883; G06F 40/274

(57) ABSTRACT

A computing device may receive an indication of a handwriting input that includes a sequence of handwritten characters, where the sequence of handwritten characters includes a sequence of word abbreviations. The computing device may determine, using a language model, a sequence of candidate words that correspond to the sequence of word abbreviations. The computing device may output, for display at a display device, a user interface that presents tire sequence of candidate words.

### BACKGROUND

Mobile computing devices such as smartphones and tablet computers may include touchscreens (e.g., capacitive touchscreens) or other presence-sensitive means with which users may interact to input text. For example, a mobile computing device may include a touchscreen that displays an on-screen virtual keyboard, and users may interact with the virtual keyboard to input text. In another example, a mobile computing device that supports handwriting recognition may enable users to input text by interacting with touchscreens to handwrite letters and words in order to input text.

### SUMMARY

In general, aspects of this disclosure are directed to techniques to enable a computing device to provide text input functionality that may enable users of the computing device to more quickly and accurately input text. Specifically, the techniques of this disclosure enable a user to provide handwriting input to input an intended sequence of words, (e.g., a phrase or a sentence) without having to provide, in the handwriting input, a handwritten letter of every letter of every word in the sequence of words. Instead, the user may provide handwriting input for an abbreviated pattern of letters for each word in a sequence of words, and the computing device may use a language model to determine a sequence of words that corresponds to the abbreviated pattern of letters for each word.

In some aspects, the techniques described herein relate to a method including: receiving, by one or more processors, an indication of a handwriting input that includes a sequence of handwritten characters, wherein the sequence of handwritten characters include a sequence of word abbreviations; determining, by the one or more processors and using a language model, a sequence of candidate words that correspond to the sequence of word abbreviations; and outputting, by the one or more processors for display at a display device, a user interface that presents the sequence of candidate words.

In some aspects, the techniques described herein relate to a computing device including a memory that stores instructions; and one or more processors that execute the instructions to: receive an indication of a handwriting input that includes a sequence of handwritten characters, wherein the sequence of handwritten characters include a sequence of word abbreviations; determine, using a language model, a sequence of candidate words that correspond to the sequence of word abbreviations; and output, for display at a display device, a user interface that presents the sequence of candidate words.

In some aspects, the techniques described herein relate to an apparatus including: means for receiving an indication of a handwriting input that includes a sequence of handwritten characters, wherein the sequence of handwritten characters includes a sequence of word abbreviations, and wherein each word abbreviation is a sequence of one or more characters; means for determining, using a language model, a sequence of candidate words that correspond to the sequence of word abbreviations; and means for outputting, for display at a display device, a user interface that presents the sequence of candidate words.

In some aspects, the techniques described herein relate to a non-transitory computer-readable storage medium storing instructions that, when executed, cause one or more processors of a computing device to; receive an indication of a handwriting input that includes a sequence of handwritten characters, wherein the sequence of handwritten characters includes a sequence of word abbreviations, and wherein each word abbreviation is a sequence of one or more characters; determine, using a language model, a sequence of candidate words that correspond to the sequence of word abbreviations; and output, for display at a display device, a user interface that presents the sequence of candidate words.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device having an abbreviated handwriting functionality, in accordance with one or more aspects of the present disclosure.

FIG. 2 is a block diagram illustrating an example computing device, in accordance with one or more aspects of the present disclosure.

FIG. 3 is a conceptual diagram illustrating techniques for automatically committing a sequence of candidate words, in accordance with aspects of the present disclosure.

FIG. 4 is a conceptual diagram illustrating an example technique for providing additional context to a language model to determine a series of candidate words, in accordance with aspects of the present disclosure.

FIG. 5 is a conceptual diagram illustrating an example technique for providing additional context to a language model to determine a series of candidate words, in accordance with aspects of the present disclosure.

FIG. 6 is a conceptual diagram illustrating techniques for editing one or more candidate words, in accordance with aspects of the present disclosure.

FIG. 7 is a conceptual diagram illustrating techniques for replacing one or more candidate words, in accordance with aspects of the present disclosure.

FIG. 8 is a conceptual diagram illustrating techniques for editing one or more candidate words, in accordance with aspects of the present disclosure.

FIG. 9 is a conceptual diagram illustrating techniques for determining a sequence of abbreviated words in a sequence of characters, in accordance with aspects of the present disclosure.

FIG. 10 is a conceptual diagram illustrating techniques for determining a sequence of abbreviated words in a sequence of characters, in accordance with aspects of the present disclosure.

FIG. 11 is a conceptual diagram illustrating an example user interface for determining a sequence of candidate words, in accordance with aspects of the present disclosure.

FIG. 12 is a conceptual diagram illustrating an example user interface for determining a sequence of candidate words, in accordance with aspects of the present disclosure.

FIG. 13 is a flowchart illustrating example operations of an example computing device having an abbreviated handwriting functionality, in accordance with one or more aspects of the present disclosure.

### DETAILED DESCRIPTION

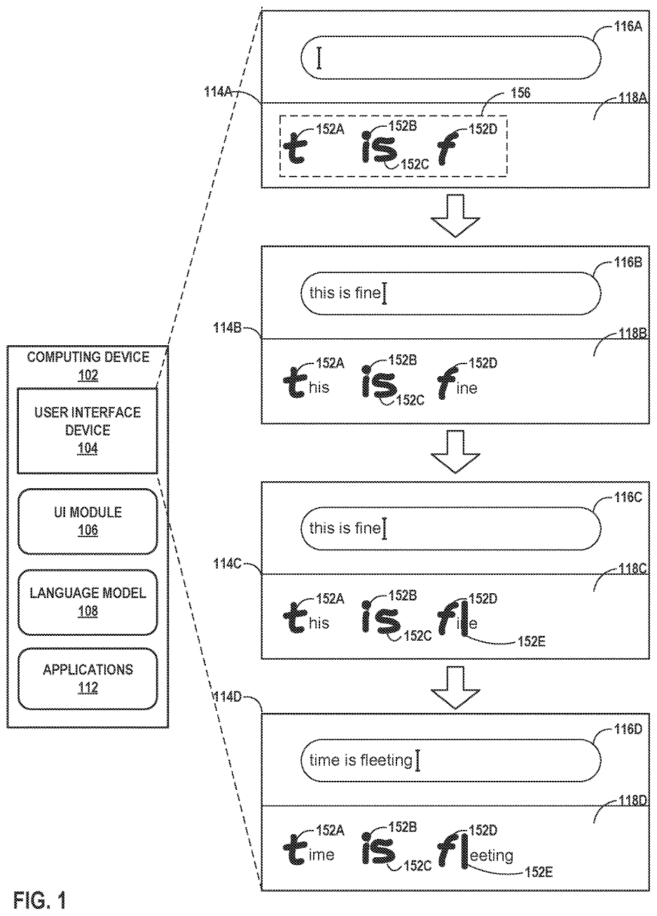

FIG. 1 is a conceptual diagram illustrating an example computing device having an abbreviated handwriting functionality, in accordance with one or more aspects of the present disclosure. As shown in FIG. 1, computing device 102 includes user interface device (UID) 104, user interface module 106 (“UI module 106”), language model 108, and applications 112.

Computing device 102 represents an individual mobile or non-mobile computing device. Examples of computing device 102 include a mobile phone (e.g., a smartphone), a tablet computer, a laptop computer, a desktop computer, a server, a mainframe, a set-top box, a television, a wearable device (e.g., a computerized watch, computerized eyewear, computerized headphones, computerized gloves, etc.), a home automation device or system (e.g., an intelligent thermostat or home assistant device), a personal digital assistant (PDA), a gaming system, a media player, an e-book reader, a mobile television platform, an automobile navigation or infotainment system, or any other type of mobile, non-mobile, wearable, and non-wearable computing device.

UID 104 of computing device 102 may function as an input device for computing device 102 and as an output device for computing device 102. UID 104 may be implemented using various technologies. For instance, UID 104 may function as an input device using a presence-sensitive input screen, such as a resistive touchscreen, a surface acoustic wave touchscreen, a capacitive touchscreen, a projective capacitive touchscreen, a pressure sensitive screen, an acoustic pulse recognition touchscreen, or another presence-sensitive display technology, such as radar-based presence-sensitive technology millimeter wave-based presence-sensitive technology, ultra-wideband-based presence-sensitive technology, and the like. In some examples, UID 104 may function as an input device using one or more audio input devices, such as one or more microphones. UID 104 may function as an output (e.g., display) device using any one or more display devices, such as a liquid crystal display (LCD), dot matrix display, light emitting diode (LED) display, microLED, organic light-emitting diode (OLED) display, e-ink, or similar monochrome or color display capable of outputting visible information to a user of computing device 102. In some examples, UID 104 may function as an audio output device and may include one or more speakers, one or more headsets, or any other audio output device capable of outputting audible information to a user of computing device 102.

In some examples, UID 104 of computing device 102 may include a presence-sensitive display that may receive tactile input from a user of computing device 102. UID 104 may receive indications of the tactile input by detecting one or more gestures from a user of computing device 102 (e.g., the user touching or pointing to one or more locations of UID 104 with a finger or a stylus pen). UID 104 may present output to a user, for instance at a presence-sensitive display. UID 104 may present the output as a graphical user interface (e.g., user interface 140), which may be associated with functionality provided by computing device 102. For example, UID 104 may present various user interfaces of components of a computing platform, operating system, applications (e.g., applications 112), or services executing at or accessible by computing device 102 (e.g., an electronic message application, an Internet browser application, a mobile operating system, etc.). A user may interact with a respective user interface to cause computing device 102 to perform operations relating to a function.

UI module 106 and language model 108 may perform operations described herein using software, hardware, firmware, or a mixture of both hardware, software, and firmware residing in and executing on computing device 102 or at one or more other remote computing devices. In some examples, UI module 106 and language model 108 may be implemented as hardware, software, and/or a combination of hardware and software. Computing device 102 may execute UI module 106 and language model 108 with one or more processors. Computing device 102 may execute any of UI module 106 and language model 108 as or within a virtual machine executing on underlying hardware. UI module 106 and language model 108 may be implemented in various ways. For example, any of UI module 106 and language model 108 may be implemented as a downloadable or pre-installed application or “app.” In another example, any of UI module 106 and language model 108 may be implemented as part of an operating system of computing device 102. Other examples of computing device 102 that implement techniques of this disclosure may include additional components not shown in FIG. 1.

UI module 106 may interpret inputs detected at UID 104. UI module 106 may relay information about the inputs detected at UID 104 to one or more associated platforms, operating systems, applications, and/or services executing at computing device 102 to cause computing device 102 to perform a function. UI module 106 may also receive information and instructions from one or more associated platforms, operating systems, applications, and/or services executing at computing device 102 (e.g., applications 112) for generating a GUI. In addition, UI module 106 may act as an intermediary between the one or more associated platforms, operating systems, applications, and/or services executing at computing device 102 and various output devices of computing device 102 (e.g., speakers, LED indicators, vibrators, etc.) to produce output (e.g., graphical, audible, tactile, etc.) with computing device 102.

Computing device 102 includes applications 112 that include functionality to perform any variety of operations on computing device 102. For instance, applications 112 may include a web browser, an email application, a text messaging application, an instant messaging application, a weather application, a video conferencing application, a social networking application, a weather application, a stock market application, an emergency alert application, a sports application, an office productivity application, a multimedia player, etc. Applications 112 may perform operations described herein using software, hardware, firmware, or a mixture of both hardware, software, and firmware residing in and executing on computing device 102 or at one or more other remote computing devices. In some examples, applications 112 may be implemented as hardware, software, and/or a combination of hardware and software. Computing device 102 may execute applications 112 with one or more processors. Computing device 102 may execute any of applications 112 as or within a virtual machine executing on underlying hardware. Applications 112 may be implemented in various ways. For example, any of applications 112 may be implemented as a downloadable or pre-installed application or “app.” In another example, any of applications 112 may be implemented as part of an operating system of computing device 102. Other examples of computing device 102 that implement techniques of this disclosure may include additional components not shown in FIG. 1.

In the example of FIG. 1, applications 112 may send data to UI module 106 that causes UID 104 to generate user interfaces (e.g., user interfaces 114A-114D, collectively “user interfaces 114”) and elements thereof. In response, UI module 106 may output instructions and information to UID 104 that cause UID 104 to display a user interface (e.g., user interface 114A) according to the information received from the application. When handling input detected by UID 104, UI module 106 may receive information from UID 104 in response to inputs detected at locations of a screen of UID 104 at which elements of the user interface are displayed. UI module 106 disseminates information about inputs detected by UID 104 to other components of computing device 102 for interpreting the inputs and for causing computing device 102 to perform one or more functions in response to the inputs.

User interfaces 114 represent graphical user interfaces with which a user of computing device 102 may interact with applications 112 of computing device 102 to input text. For example, user interface 114A includes text input field 116A, and a user of computing device 102 may interact with UID 104 to input text into text input field 116A using UID 104. Computing device 102 may provide one or more ways for a user to input text. For example, UID 104 may display a virtual keyboard, and a user may provide user input at UID 104 to interact with the virtual keyboard, such as by typing characters using keys of the virtual keyboard, to input text at computing device 102.

However, unlike a physical keyboard, a virtual keyboard may not provide the user with any tactile feedback when the user interacts with keys of the virtual keyboard to input text. The lack of tactile feedback may make it difficult for some users to accurately and quickly judge whether or not they have successfully selected an intended key of the virtual keyboard and may make it easy for users to accidentally input an unintended character. As such the lack of tactile feedback may reduce the speed at which users may be able to input text at UID 104 and may increase the number of typos in text inputted using the virtual keyboard.

Furthermore, in examples where computing device 102 is a smartphone having a relatively small touchscreen (e.g., a touchscreen having a diagonal size of less than seven inches), the size of the virtual keyboard displayed by UID 104 may be very small, which may make it difficult for some users to accurately and quickly input text using the virtual keyboard. In examples where computing device 102 is a tablet computer, computing device 102 may have a relatively larger touchscreen (e.g., a touchscreen having a diagonal size of seven inches or more) that may display a relatively larger virtual keyboard compared with a smartphone. However, the lack of tactile feedback when typing on such a larger virtual keyboard may still decrease the speed at which users may be able to input text at UID 104 and may increase the number of typos in text inputted using the virtual keyboard.

In addition, when inputting a sequence of words, it may be difficult for users to easily edit previously inputted words using a virtual keyboard. For example, a user may have to perform one or more gestures to manipulate a cursor back to a previous word in order to edit that word. Such cursor manipulation may be especially challenging on devices such as smartphones having relatively small displays.

In some examples, computing device 102 may enable users to input text by interacting with UID 104 to provide handwriting input, such as by inputting a sequence of strokes that corresponds to handwritten text, and computing device 102 may be able to perform handwriting recognition to convert the handwriting input into text. However, it may be extremely time consuming for users to provide handwriting input to input text at UID 104. For example, to input a phrase containing multiple words, users may have to interact with UID 104 to handwrite each individual letter of each word in the phrase, which may be much slower than inputting the same phrase using a virtual keyboard.

In accordance with aspects of this disclosure, computing device 102 provides an abbreviated handwriting technique for text input that may enable users of computing device 102 to interact with UID 104 to more quickly and accurately input text compared with other text input techniques. Specifically, computing device 102 may enable a user to input a sequence of words, such as a phrase or a sentence, by providing handwriting input of a word abbreviation of each word in the sequence of words at UID 104, where a word abbreviation of a multi-letter word may be a sequence of one or more letters having fewer letters than the word. Because an abbreviation of a word may have fewer letters than the word itself, it may be faster to provide handwriting input of a sequence of word abbreviations to input a sequence of words that corresponds to the sequence of word abbreviations compared with providing handwriting input of each letter in the sequence of words.

A word abbreviation of a word may be a sequence of one or more letters that appear in the same order in the word but are not necessarily contiguous letters in the word. In other words, a word abbreviation of a word may be a subsequence of the word. For example, the word “people” may have a word abbreviation of “ppl” because the sequence of letters “ppl” appear in the same order in the word “people” but are not necessarily contiguous letters in the word “people.” In some examples, a word abbreviation of a word may also have the same initial letter as the word. For example, any word abbreviation of the word “scuba” may be required to start with the letter “s” (i.e., have an initial letter “s”) because “s” is the initial letter of the word “scuba” In some examples, a word abbreviation of a word may be a single letter, such as the initial letter of the word, and computing device 102 may enable a user to input a sequence of words by providing handwriting input of an initial letter of each word in the sequence of words at UID 104

As such, the user of computing device 102 may interact with UID 104 to provide handwriting input that corresponds to a sequence of word abbreviations in order to input a sequence of words that correspond to the sequence of word abbreviations. In the example of FIG. 1, the word abbreviation of a word is the initial letter of the word, and the user of computing device 102 may interact with UID 104 to provide handwriting input that corresponds to a sequence of word abbreviations, which is a sequence of characters, in order to input a sequence of words that corresponds to the sequence of word abbreviations. That is, a user that intends to input a sequence of words (e.g., a phrase or a sentence) may input, at UID 104, one or more letters of each word in the intended sequence of words without necessarily inputting every letter of every word in the intended sequence of words, and computing device 102 may be able to determine, based on the sequence of characters inputted by the user, the intended sequence of words.

In the example of FIG. 1, UID 104 may display user interface 114A that includes text input field 116A and text input interface 118A. Text input interface 118A may be a portion of user interface 114A within which the user may interact to provide handwriting input to input text that may be inserted into text input field 116A. The user of computing device 102 may interact with UID 104 to input a sequence of characters by input a series of strokes to write each character at UID 104.

If the user of computing device 102 intends to enter a sequence of words “time is fleeting” at computing device 102, the user may determine that the sequence of word abbreviations “t”, “is”, and “f” correspond to the intended sequence of words “time is fleeting”. The user may therefore interact with UID 104 to provide handwriting input 156 at a location of user interface 114A that corresponds to text input interface 118A to input the sequence of characters “tisf”. That is, the user may provide handwriting input 156 that includes handwritten characters 152A-152D (“handwritten characters 152”), which may be handwritten character 152A of “t”, followed in sequence by handwritten character 152B of “i”, followed in sequence by handwritten character 152C of “s”, and followed in sequence by handwritten character 152D of “f”.

Computing device 102 may receive an indication of handwriting input corresponding to a sequence of characters and may, in response, perform any suitable handwriting recognition technique to recognize the handwritten characters in the handwritten input as a sequence of characters and determine a sequence of candidate words based at least in part on the sequence of characters recognized from the handwriting input. For example, UI module 106 may receive, from UID 104, an indication of the handwriting input 156 that includes the sequence of handwritten characters 152, and computing device 102 may perform handwriting recognition of the sequence of handwritten characters 152 to determine the sequence of characters that correspond to handwriting input 156.

Because some word abbreviations may be a sequence of two or more characters, such as the word abbreviation “is”, the user may provide handwriting input 156 to input the sequence of handwritten characters 152 of “tisf” in ways that groups together the handwritten characters of the same word abbreviation and spaces apart handwritten characters of different abbreviations. Specifically, the user may input handwritten characters that are part of the same word abbreviation close to each other, while leaving a space between handwritten characters of two separate word abbreviations, such as by spacing apart a handwritten character the last character of a sequence characters making up a word abbreviation and the next handwritten character that is the first character of another sequence of word abbreviations.

In the example of FIG. 1, handwriting input 156 includes the sequence of handwritten characters 152A-152D of “t”, “1”, “s”, and “f”. As can be seen, handwritten character 152A of “t” is spaced apart from the next sequence of handwritten characters 152B and 152C of “i” and “s”, which is spaced apart from the next handwritten character 152D of “f”. In this way, handwriting input 156 may indicate that the sequence of word abbreviations in the sequence of handwritten characters 152 are “t”, “is”, and “f”.

Computing device 102 may therefore be able to determine a sequence of word abbreviations included in the sequence of handwritten characters 152 based at least in part on the locations of each of the handwritten characters 152 in user interface 114A and the distances between the locations of each of the handwritten characters 152 in user interface 114A. For example, computing device 102 may determine, for each handwritten character, the distance between the location of the handwritten character and the location of neighboring handwritten characters in the sequence of handwritten characters 152 provided by the user. In this way, computing device 102 may determine that the sequence of word abbreviations in the sequence of handwritten characters are “t”, “is”, and “f”.

Computing device 102 may use language model 108 to determine a sequence of candidate words that correspond to the inputted sequence of word abbreviations. Language model 108 may be a mathematical model, such as in the form of one or more neural networks, trained on a large corpus of text via machine learning, that uses probabilistic techniques to determine, given a sequence of word abbreviations, a sequence of words most likely to be the intended sequence of words out of multiple sequences of words that each correspond to the sequence of word abbreviations. For example, computing device 102 may use language model 108 to determine a plurality of sequences of words, each of which corresponds to the sequence of word abbreviations, and may determine a sequence of words that is most likely to be an intended sequence of words, given the sequence of word abbreviations, out of the plurality of sequences of words. Computing device 102 may therefore determine the sequence of words that is most likely to be an intended sequence of words given the sequence of word abbreviations to be a sequence of candidate words that correspond to the word abbreviations.

Language model 108 may follow one or more rules or constraints to determine the sequence of candidate words that correspond to the sequence of word abbreviations. For example, language model 108 may be constrained to determining a sequence of candidate words that have a sequence of initial characters that correspond to the sequence of initial characters of the sequence of word abbreviations. Further, language model 108 may be constrained to determining, for each word abbreviation that includes a sequence of two or more characters, a corresponding candidate word that includes each of the sequence of two or more characters in order of the sequence of two or more characters.

Thus, given a sequence of word abbreviations “t”, “is”, and “f”, language model 108 may be constrained to determine a sequence of candidate words that includes a first candidate word that starts with the character “t”, followed by a second candidate word that starts with the character “i”, followed by a third candidate word that starts with the character “f”. Further, language model 108 may be constrained to determine that the candidate word that corresponds to the word abbreviation “is” includes, in order, the character “i” followed by the character “s”.

In the example of FIG. 1, computing device 102 may input information such as the sequence of word abbreviations “t”, “is”, and “f” that correspond to handwriting input 156 into language model 108, and computing device 102 may use language model 108 may determine that “this is fine” is a sequence of words that is most likely to correspond to the sequence of word abbreviations “t”, “is”, and “f”. Computing device 102 may therefore determine “this is fine” to be the sequence of candidate words that corresponds to the inputted word abbreviations “t”, “is”, and “f”.

Computing device 102 may, in response to determining a sequence of candidate words that corresponds to the sequence of abbreviations, output an indication of the sequence of candidate words for display at UID 104. UI module 106 may therefore output instructions and information to UID 104 that cause UID 104 to update the user interface being displayed to include an indication of the sequence of candidate words “this is fine”. For example, computing device 102 may output, for display at UID 104, user interface 114B, which is user interface 114A that is updated to include the sequence of candidate words “this is fine”. Specifically, user interface 114B includes text input field 116B that corresponds to text input field 116A in user interface 114A and text input interface 118B that corresponds to text input interface 118A in user interface 114A, and text input interface 118B of user interface 114B may present the sequence of candidate words “this is fine”.

Computing device 102 may output a sequence of candidate words in any suitable form. For example, UID 104 may present each character that corresponds to a handwritten character entered via handwriting input 156 in a candidate word in handwritten form, such as in the form of a corresponding handwritten character in the handwriting input 156 inputted at UID 104. UID 104 may also present any remaining characters that do not correspond to characters entered via handwriting input 156 in the candidate word as digital text (e.g., non-handwritten input, such as characters generated by computing device 102).

In the example of FIG. 1, the initial character of the candidate word “this” is the character “t” inputted via handwritten character 152A, the two characters of the candidate word “is” are the characters “i” and “s” in the sequence of characters inputted via handwritten characters 152B and 152C, and the initial character of the candidate word “fine” is the character “f” inputted via handwritten character 152D. As such, UID 104 may present, in user interface 114B, the candidate word “this” as handwritten character 152A of “t” followed by the sequence of non-handwritten characters “his.” UID 104 may present, in user interface 114B, the candidate word “is” as handwritten character 152B of “i” followed by handwritten character 152C of “s.” UID 104 may present, in user interface 114B, the candidate word “fine” as handwritten character 152D of “f” followed by the sequence of non-handwritten characters “ine.”

Computing device 102 may also, in response to determining a sequence of candidate words that corresponds to the sequence of characters inputted at UID 104, input the sequence of candidate words into a text input field of user interface 114B, such as text input field 116B. For example, computing device 102 may input the sequence of candidate words “this is fine” into text input field 116B.

If the user of computing device 102 determines that the sequence of candidate words does not match an intended sequence of words that corresponds to the sequence of word abbreviations inputted by the user, the user may further interact with UID 104 to provide additional handwriting input, and computing device 102 may determine a new sequence of candidate words based on the additional handwriting input. For example, if the user had intended to input the sequence of words “time is fleeting” by interacting with UID 104 to input the sequence of word abbreviations “t”, “is”, and “f”, the sequence of candidate words “this is fine” determined by computing device 102 may not match the user's intended sequence of words. Thus, the user may further interact with UID 104 to provide additional handwriting input of one or more additional characters, which may provide additional context regarding the user's intended sequence of words, and computing device 102 may use language model 108 to determine, based at least in part on the additional handwriting input, a new sequence of candidate words.

For example, the user may interact with UID 104 to provide an additional handwriting input of an additional character at a location of a user interface outputted by UID 104 that corresponds to a candidate word to add the additional character to the word abbreviation that corresponds to the candidate word. Computing device 102 may therefore determine, based on the updated sequence of word abbreviations, a new sequence of candidate words.

In the example of FIG. 1, computing device 102 may output, at UID 104, user interface 114C, which corresponds to user interface 114B, that includes text input field 116C and text input interface 118C, to present, in text input interface 118C, the sequence of candidate words “this is fine” that corresponds to the sequence of word abbreviations “t”, “is”, and “f”. The user may therefore interact with UID 104 to provide an additional handwriting input of an additional character at a location of user interface 114C that corresponds to a candidate word to update the word abbreviation associated with the candidate word.

A location of user interface 114C that corresponds to a particular candidate word may be a location of user interface 114C that overlaps at least a portion of the particular candidate word that is being presented in the user interface 114C. In some examples, the location of user interface 114C that corresponds to a candidate word may be a location that overlaps at least a portion of the candidate word presented in user interface 114C but does not overlap one or more handwritten characters in the candidate word presented in user interface 114C.

As shown in FIG. 1, the user may interact with UID 104 to provide additional handwriting input that includes handwritten character 152E of “1” over a portion of the candidate word “fine” in order to add the character “1” to the word abbreviation “f” that corresponds to the candidate word “fine”. Because the word “fine” in the sequence of candidate words “this is fine” includes the handwritten character “f” followed by non-handwritten characters “ine”, the location of user interface 114C that corresponds to the word “fine” may be a location of user interface 114C that overlaps at least a portion of the non-handwritten characters “ine” but does not overlap the handwritten character “f”.

Computing device 102 may, in response to the inputting handwritten character 152E of “1” over a portion of the candidate word “fine” in user interface 114C, add the character “I” to the word abbreviation of “f” in the sequence of word abbreviations, thereby updating the sequence of word abbreviations to be “t”, “is”, and “fl”. Computing device 202 may, in response to updating the sequence of word abbreviations, use language model 108 to determine a new sequence of candidate words that correspond to the updated sequence of word abbreviations “t”, “is”, and “fl”. In the example of FIG. 1, language model 108 may determine that a new sequence of candidate words “time is fleeting” corresponds to the updated sequence of word abbreviations “t”, “is”, and “fl”.

Computing device 102 may therefore output the new sequence of candidate words “time is fleeting” for display at UID 104. For example, computing device 102 may output, for display at UID 104, user interface 114D that corresponds to user interface 114C, that presents the new sequence of candidate words “time is fleeting” in text input interface 118D of user interface 114D. Computing device 102 may also input the new sequence of candidate words “time is fleeting” into text input field 116D of user interface 114D. For example, if the user determines that the sequence of candidate words determined by computing device 102 matches the user's intended sequence of words, the user may interact with a user interface element in the user interface (e.g., user interface 114D) to select the sequence of candidate words, such as to commit the sequence of candidate words as the sequence of words inputted into text input field 116D. In this way, computing device 102 may enable the user to input word abbreviations and edit those word abbreviations in order to enter a sequence of words via handwriting input without having to provide handwriting input to enter each character of the sequence of words.

The techniques of this disclosure may provide one or more advantages. By enabling users to handwrite words in abbreviated form in order to enter text at a computing device and then using a language model to determine the words users intended to enter, the techniques of this disclosure reduces the amount of time and effort it may take for users to provide handwritten input compared with handwritten input techniques that require users to handwrite every character of every word. Furthermore, by enabling users to easily edit candidate words by providing additional handwritten characters at locations of the user interface that correspond to the candidate words to be edited, the techniques of this disclosure may reduce the amount of time and effort it may take for users to edit candidate words compared with an on-screen virtual keyboard. In these ways, the techniques of this disclosure may improve the technical field of user interactions by providing ways to more quickly and efficiently enter text at a computing device.

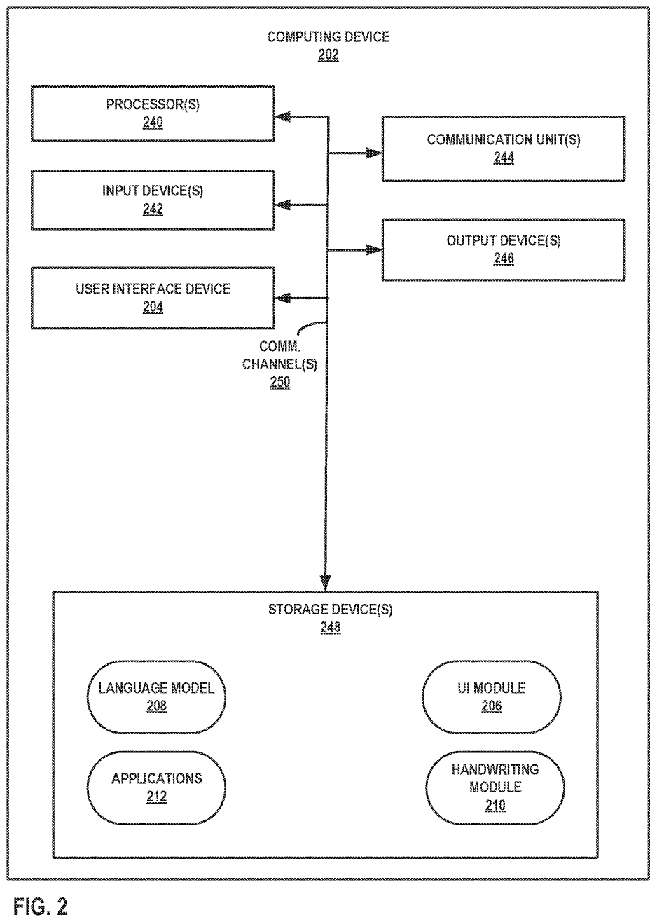

FIG. 2 is a block diagram illustrating an example computing device 202, in accordance with one or more aspects of the present disclosure. Computing device 202 of FIG. 2 is an example of computing device 102 of FIG. 1. Computing device 202 is only one particular example of computing device 102 of FIG. 1, and many other examples of computing device 102 may be used in other instances. In the example of FIG. 2, computing device 202 may be a mobile computing device (e.g., a smartphone), or any other computing device. Computing device 202 of FIG. 2 may include a subset of the components included in example computing device 202 or may include additional components not shown in FIG. 2.

As shown in the example of FIG. 2, computing device 202 includes user interface device 204 (“UID 204”), one or more processors 240, one or more input devices 242, one or more communication units 244, one or more output devices 246, and one or more storage devices 248. Storage devices 248 of computing device 202 also include UI module 206, language model 208, handwriting module 210, and applications 212. Language model 208 is an example of language model 108 of FIG. 1, and applications 212 are examples of applications 112 of FIG. 1.

Communication channels 250 may interconnect each of the components 240, 242, 244, 246, 248, and 204 for inter-component communications (physically, communicatively, and/or operatively). In some examples, communication channels 250 may include a system bus, a network connection, an inter-process communication data structure, or any other method for communicating data.

One or more input devices 242 of computing device 202 may be configured to receive input. Examples of input are tactile, audio, and video input. Input devices 242 of computing device 202, in one example, includes a presence-sensitive display, touch-sensitive screen, mouse, keyboard, voice responsive system, video camera, microphone or any other type of device for detecting input from a human or machine.

One or more output devices 246 of computing device 202 may be configured to generate output. Examples of output are tactile, audio, and video output. Output devices 246 of computing device 202, in one example, includes a presence-sensitive organic light emitting diode (OLED) display, sound card, video graphics adapter card, speaker, monitor, a presence-sensitive liquid crystal display (LCD), or any other type of device for generating output to a human or machine.

One or more communication units 244 of computing device 202 may be configured to communicate with external devices via one or more wired and/or wireless networks by transmitting and/or receiving network signals on the one or more networks. Examples of communication unit 244 include a network interface card (e.g. such as an Ethernet card), an optical transceiver, a radio frequency transceiver, a GPS receiver, or any other type of device that can send and/or receive information. Other examples of communication units 244 may include short wave radios, cellular data radios, wireless network radios, as well as universal serial bus (USB) controllers.

UID 204 is an example of UID 104 of FIG. 1. In some examples, UID 204 of computing device 202 may include functionality of input devices 242 and/or output devices 246. In the example of FIG. 2, UID 204 may be or may include a presence-sensitive input device, such as a presence-sensitive display (e.g., a touchscreen). In some examples, a presence sensitive input device may detect an object at and/or near a screen. As one example range, a presence-sensitive input device may detect an object, such as a finger or stylus that is within 2 inches or less of the screen. The presence-sensitive input device may determine a location (e.g., an (x, y) coordinate) of a screen at which the object was detected. In another example range, a presence-sensitive input device may detect an object six inches or less from the screen and other ranges are also possible. The presence-sensitive input device may determine the location of the screen selected by a user's finger using capacitive, inductive, and/or optical recognition techniques. In some examples, a presence sensitive input device also provides output to a user using tactile, audio, or video stimuli as described with respect to output device 246, e.g., at a display. In the example of FIG. 2, UID 204 may present a user interface.

While illustrated as an internal component of computing device 202, UID 204 also represents an external component that shares a data path with computing device 202 for transmitting and/or receiving input and output. For instance, in one example, UID 204 represents a built-in component of computing device 202 located within and physically connected to the external packaging of computing device 202 (e.g., a screen on a mobile phone). In another example, UID 204 represents an external component of computing device 202 located outside and physically separated from the packaging of computing device 202 (e.g., a monitor, a projector, etc. that shares a wired and/or wireless data path with a tablet computer).

One or more storage devices 248 within computing device 202 may store information for processing during operation of computing device 202. In some examples, storage device 248 is a temporary memory, meaning that a primary purpose of storage device 248 is not long-term storage. Storage devices 248 on computing device 202 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 248, in some examples, also include one or more computer-readable storage media. Storage devices 248 may be configured to store larger amounts of information than volatile memory. Storage devices 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 248 may store program instructions and/or information (e.g., data) associated with UI module 206, language model 208, handwriting module 210, and applications 212.

One or more processors 240 may implement functionality and/or execute instructions within computing device 202. For example, processors 240 on computing device 202 may receive and execute instructions stored by storage devices 248 that execute the functionality of UI module 206, language model 208, handwriting module 210, and applications 212. These instructions executed by processors 240 may, for example, cause handwriting module 210 to recognize handwritten characters inputted at UID 204 as characters and cause language model 208 to determine, for a sequence of word abbreviations, a sequence of candidate words.

Language model 208, handwriting module 210, and applications 212 are described below executing at one or more processors 240. It should be understood that one or more processors 240 are configured to execute language model 208, handwriting module 210, and applications 212 to perform the functionality of language model 208, handwriting module 210, and applications 212 described below. That is, one or more processors 240 are configured to execute the instructions of language model 208, handwriting module 210, and applications 212 to perform the functionality of, language model 208, handwriting module 210 applications 212 described below.

UID 204 is configured to receive handwritten input that includes a sequence of handwritten characters that correspond to a sequence of word abbreviations, and one or more processors 240 are configured to execute UI module 206 to receive, from UID 204, an indication of the handwriting input.

A word abbreviation of a corresponding word may be a sequence of one or more characters that appear in the same order in the corresponding word, but are not necessarily contiguous characters in the word, where the word abbreviation and the corresponding word each have the same initial character. Word abbreviations may follow one or more constraints determined by computing device 202. In some examples, each word abbreviation may include only the initial character of a corresponding word. In some examples, each word abbreviation may be a variable-length prefix of a corresponding word.

One or more processors 240 are configured to execute handwriting module 210 to perform handwriting recognition to recognize the sequence of handwritten characters in the handwriting input. Handwriting module 210 may be trained via machine learning to identify and interpret handwritten text. For example, handwriting module 210 may include one or more neural networks trained over a dataset of handwritten text to enable handwriting module 210 to recognize text from handwriting input.

In some examples, handwriting module 210 may be a handwriting recognizer trained to recognize entire handwritten words and sentences that is adapted to perform handwriting recognition of characters making up word abbreviations. For example, handwriting module 210 may be modified to determine, based on a single handwriting stroke, a character that corresponds to the stroke, without taking into account information such as previously entered strokes of one or more other characters and words. In examples where a character may be made up of two strokes, such as the characters “i” and “p”, handwriting module 210 may use a time threshold to determine whether two consecutive strokes may make up a single word. For example, if handwriting module 210 determines that two consecutive strokes are entered within a specified time period, handwriting module 210 may attempt to determine a character from the two consecutive strokes.

In some examples, one or more processors 240 are configured to execute handwriting module 210 to determine the sequence of word abbreviations in the handwriting input. That is, handwriting module 210 may be able to recognize and group the sequence of handwritten characters in the handwriting input into groups of one or more characters to determine the sequence of word abbreviations from the handwriting input. For example, handwriting module 210 may be able to determine, from the handwriting input, a sequence of word abbreviations based at least in part on the locations of each of the handwritten characters in an user interface and the distances between the locations of each of the handwritten characters in the user interface.

One or more processors 240 are configured to execute language model 208 to determine, based on the handwritten input that corresponds to a sequence of word abbreviations, a sequence of candidate words that correspond to the sequence of word abbreviations. Language model 208 may be a mathematical model, trained on a large corpus of text via machine learning, that uses probabilistic techniques to determine, given a sequence of word abbreviations, a sequence of words most likely to be the intended sequence of words that correspond to the sequence of word abbreviations out of multiple sequences of words that each correspond to the sequence of word abbreviations.

One or more processors 240 are therefore configured to execute language model 208 to determine a sequence of candidate words that correspond to the sequence of word abbreviations as the sequence of words most likely to be the intended sequence of words that correspond to the sequence of word abbreviations. out of multiple sequences of words that each correspond to the sequence of word abbreviations.

In some examples, language model 208 may be an n-gram language model. An n-gram language model may be a type of statistical language model that is used to predict the next word in a sequence of words by using statistical techniques to analyze a large corpus of text and then uses that analysis to estimate the probability of each word occurring after a given sequence of words.

In some examples, language model 208 includes one or more neural networks that are trained via machine learning to learn statistical relationships between words in a language. Language model 208 may be trained on a large dataset of textual data and may be trained to accurately capture nuances and complexities of natural language. In contrast to an n-gram model that uses a limited amount of context, such as a previous sequence of n consecutive words, to predict the next word in a text, language model 208 implemented via one or more neural networks may be able to use a large set of contextual information to predict, given a sequence of word abbreviations, a sequence of candidate words. For example, language model 208 may use contextual information such as the handwritten characters themselves, the locations of the handwritten characters in a user interface, previous sentences in a document, previous messages sent and received during an interactive messaging session (e.g., the messages sent and received during a text messaging conversation), and the like, to determine, given handwriting input that corresponds to a sequence of word abbreviations, a corresponding sequence of candidate words.

In some examples, language model 208 may be trained to use context such as spacing between the locations of handwritten characters as contextual information to determine a sequence of candidate words that correspond to a sequence of word abbreviations. For example, if language model 208 determines that the space between a first handwritten character of a first word abbreviation and a second handwritten character of a second word abbreviation is large, language model 208 may determine that it is more probable that the first word abbreviation is an abbreviation of a relatively long word. In another example, if language model 208 determines that the space between a first handwritten character of a first word abbreviation and a second handwritten character of a second word abbreviation is small, language model 208 may determine that it is more probable that the first word abbreviation is an abbreviation of a relatively short word.

In some examples, language model 208 may be trained to determine sequences of candidate words in ways that tolerate ambiguities in handwritten input provided by the user. That is, language model 208 may not strictly follow the handwritten characters recognized by handwriting module 210 as word abbreviations from handwriting input to determine sequences of candidate words. Instead, language model 208 may be trained to, in some cases, replace one or more characters in the sequence of word abbreviations determined by handwriting module 210 to determine a sequence of candidate words that correspond to the sequence of word abbreviations. Language model 208 may be trained to perform such replacement of one or more characters in the sequence of word abbreviations based on context, such as one or more preceding sentences, previous messages sent and received during an interactive messaging session, and the like.

For example, a handwritten character “u” may sometimes be confused with a handwritten character “a”. As such, given a sequence of characters “iafas” recognized by handwriting module 210, language model 208 may determine, based on context such as a preceding sentence of “where are you from?”, that there is a high likelihood that the fourth character “a” in the sequence of characters “iafas” is actually the character “u”. Thus, language model 208 may generate, based on the sequence of characters “iafas”, a sequence of candidate words “I am from the United States” having a sequence of initial characters “iafus”, which corresponds to the sequence of characters “iafas” recognized by handwriting module 210 with the fourth character “a” in the sequence of characters “iafas” replaced with the character “u”.

One or more processors 240 are configured to execute UI module 206 to output an indication of the sequence of candidate words for display at UID 204. For example, one or more processors 240 are configured to execute UI module 206 to output or update a user interface to present the sequence of candidate words, which may be displayed by UID 204. Because each candidate word includes one or more characters of a corresponding word abbreviation that is entered via handwritten input at UID 204, UI module 206 may output an indication of each candidate word that includes one or more characters of the candidate word in handwritten form, with any remaining characters of the candidate word in non-handwritten form, such as in digital text. This may enable the user of computing device 202 to easily visualize which characters in a candidate word were inputted via handwriting input.

In some examples, one or more processors 240 are configured to execute an application from applications 212 to receive an indication of the sequence of candidate words and to input the sequence of candidate words into one or more text input fields of the application. For example, an e-mail application may receive an indication of the sequence of candidate words and input the sequence of candidate words into one or more text input fields of an e-mail message, such as into the Subject field of the e-mail message.

UID 204 may, in response to displaying a user interface that includes the sequence of candidate words, receive additional user input to update the sequence of candidate words. For example, UID 204 may receive additional user input such as in the form of an additional handwriting input, gestures, and the like. One or more processors 240 are configured to execute UI module 206 to receive an indication of the additional user input from UID 204 and are configured to execute handwriting module 210 to perform handwriting recognition of handwriting included in the additional user input to determine one or more handwritten characters. In some examples, one or more processors 240 are also configured to execute handwriting module 210 to update the sequence of word abbreviations based on the one or more handwritten characters included in the additional user input to determine a new sequence of word abbreviations.

One or more processors 240 are configured to execute language model 208 to determine, based on the new sequence of word abbreviations, a new sequence of candidate words that correspond to the new sequence of word abbreviations. That is, language model 208 may determine a sequence of words most likely to be the intended sequence of words that correspond to the new sequence of word abbreviations. out of multiple sequences of words that each correspond to the new sequence of word abbreviations, and may determine the new sequence of candidate words as the sequence of words most likely to be the intended sequence of words that correspond to the new sequence of word abbreviations

One or more processors 240 are configured to execute UI module 206 to, in response to language model 208 determining the new sequence of candidate words, output an indication of the new sequence of candidate words for display at UID 204. For example, one or more processors 240 are configured to execute UI module 206 to output or update a user interface to include the new sequence of candidate words, which may be displayed by UID 204. In some examples, one or more processors 240 are configured to execute an application from applications 212 to receive an indication of the new sequence of candidate words and to input the new sequence of candidate words into one or more text input fields of the application.

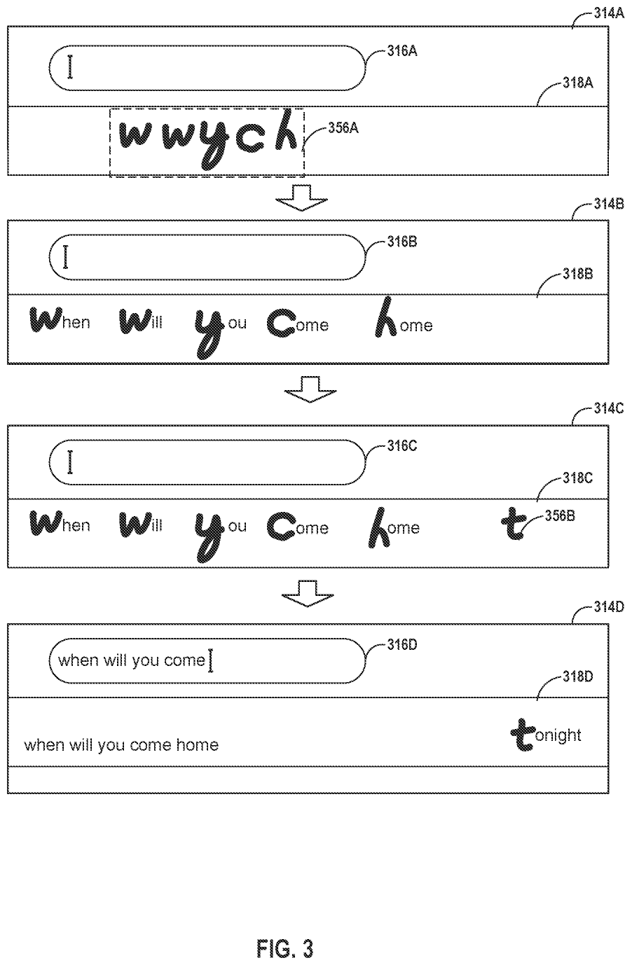

FIG. 3 is a conceptual diagram illustrating techniques for automatically committing a sequence of candidate words, in accordance with aspects of the present disclosure. For purposes of illustration only, FIG. 3 is described herein within the context of computing device 202 of FIG. 2.

A user of computing device 202 may interact with UID 204 of computing device 202 to commit a sequence of candidate words that corresponds to a sequence of word abbreviations inputted by the user, such as by interacting with a user interface element displayed by UID 204 associated with functionality of committing a sequence of candidate words. For example, the user may interact with UID 204 to commit a sequence of candidate words when the sequence of candidate words matches the sequence of words that the user was intending to input by providing the handwriting input of the sequence of word abbreviations.

When computing device 202 commits a sequence of candidate words, the sequence of candidate words may become a committed sequence of words that may not be changed or replaced by the user inputting additional word abbreviations that enable computing device 202 to use language model 208 to determine additional sequences of candidate words corresponding to the additional word abbreviations. As such, the user of computing device 202 may interact with UID 204 to commit a sequence of candidate words to prevent changes to the committed sequence of words.

In some examples, when the user interacts with UID 204 to provide handwriting input of the sequence of word abbreviations to input a sequence of words in a text input field, computing device 202 may refrain from inputting a sequence of candidate words until the user commits the sequence of words. As such, the user may interact with UID 204 to commit a sequence of candidate words in order to input the committed sequence of words into the text input field.

As shown in FIG. 3, UID 204 of computing device 202 may display user interface 314A that includes text input field 316A and text input interface 318A. Text input interface 318A may be a portion of user interface 314A within which the user may interact to provide handwriting input to input text that may be inserted into text input field 316A.

The user of computing device 202 may attempt to input an intended sequence of words into text input field 316A by interacting with UID 204 to input a sequence of word abbreviations that correspond to the intended sequence of words. For example, the user of computing device 202 may interact with UID 204 to provide, at a location of user interface 314A that corresponds to text input interface 318A, handwriting input 356A that corresponds to the sequence of word abbreviations.

In the example of FIG. 3, a word abbreviation for a corresponding word is constrained to be a single character that is the initial character for the corresponding word. Because of this constraint, the user may therefore be able to input the sequence of word abbreviations as a sequence of handwritten characters without having to space apart each handwritten character. As such, as shown in FIG. 3, the user may input a sequence of word abbreviations as a sequence of characters by providing handwriting input 356A that includes a sequence of handwritten characters, such as a first handwritten character “w”, followed by a second handwritten character “w”, followed by a third handwritten character “y”, followed by a fourth handwritten character “c”, followed by a fifth handwritten character “h” that are all located in user interface 314A sequentially right next to each other.

Computing device 202 may use language model 208 to determine a sequence of candidate words that correspond to the sequence of word abbreviations inputted via handwriting input 356A. In the example where each word abbreviation is a single character, the sequence of word abbreviations may be a sequence of characters that correspond to handwriting input 356A, and computing device 202 may use language model 208 to determine a sequence of candidate words having a sequence of initial characters that correspond to the sequence of characters making up the sequence of word abbreviations. For example, given the sequence of word abbreviations “w”, “w”, “y”, “c”, and “h” inputted via handwriting input 356A, computing device 202 may use language model 208 to determine that a sequence of candidate words “when will you come home” corresponds to the sequence of word abbreviations.

Computing device 202 may, in response to determining a sequence of candidate words that correspond to the sequence of word abbreviations, output the sequence of candidate words for display at UID 204. For example, computing device 202 may output user interface 314B, which is user interface 314A updated to present the sequence of candidate words “when will you come home”. Specifically, user interface 314B includes text input field 316B that corresponds to text input field 316A in user interface 314A and text input interface 318B that corresponds to text input interface 318A in user interface 314A, and computing device 202 may present the sequence of candidate words “when will you come home” in text input interface 318B of user interface 314B.

Computing device 202 may, after determining a sequence of candidate words, automatically commit at least a portion of a sequence of candidate words in response to receiving an indication of an additional handwriting input if the location of the additional handwriting input in text input interface 318B of user interface 314B is indicative of an attempt to enter a new word abbreviation that follows the final word in the sequence of candidate words. A language may have a writing direction, which refers to the direction in which text is written, printed, or otherwise outputted. For example, the English language has a writing direction that is left to right, so that words are written from left to right. In the example of FIG. 3 where the sequence of candidate words is in English, the location of the additional handwriting input may be indicative of an attempt to enter a new word abbreviation that follows the final word in the sequence of candidate words if the location of the additional handwritten input is to the right of the final candidate word in the sequence of candidate words.

In the example of FIG. 3, computing device 202 may output user interface 314C, which corresponds to user interface 314B. Specifically, user interface 314C includes text input field 316C that corresponds to text input field 316B in user interface 314B and text input interface 318C that corresponds to text input interface 318B in user interface 314B, where text input interface 318C includes the sequence of “when will you come home” that corresponds to the sequence of word abbreviations “w”, “w”, “y”, “c”, “h” provided by handwriting input 356A.

Computing device 202 may, after determining the sequence of candidate words “when will you come home” and presenting the sequence of candidate words in user interface 314C, receive an indication of an additional handwriting input 356B to the right of the final candidate word “home” within text input interface 318C. Because the additional handwriting input 356B to the right of the final candidate word “home”, the location of additional handwriting input 356B indicates that the additional handwriting input 356B is an attempt to enter a new word that follows the final candidate word “home”.

Computing device 202 may therefore, in response to receiving the indication of additional handwriting input 356B, automatically commit the entire sequence of candidate words “when will you come home”. In some examples, computing device 202 may, in response to committing a sequence of candidate words, input the committed sequence of words into a text input field. For example, computing device 202 may update user interface 318D by outputting user interface 314D, which corresponds to user interface 314C, includes text input field 316D that corresponds to text input field 316C in user interface 314C and text input interface 318D that corresponds to text input interface 318C in user interface 314C, and computing device 202 may, in response to committing the sequence of candidate words “when will you come home”, input the committed sequence of words “when will you come home” into text input field 316D.

Further, computing device 202 may also, in response to committing a sequence of candidate words, digitize any handwritten characters in the sequence of candidate characters presented in user interface 314D to non-handwritten form, In the example where the sequence of initial characters “w”, “w”, “y”, “c”, and “h” of the sequence of the candidate words are each presented as a handwritten character, computing device 202 may digitize the sequence of initial characters of the committed sequence of words into non-handwritten form, such as shown in user interface 314D.

Computing device 202 may, after committing a sequence of candidate words, continue to determine additional candidate words that correspond to additional handwriting inputs received by UID 204. For example, computing device 202 may, in response to receiving an indication of additional handwriting input 356B, determine a candidate word “tonight” that corresponds to additional handwriting input 356B, and may present the candidate word tonight in user interface 318D after the commit sequence of words “when will you come home”.

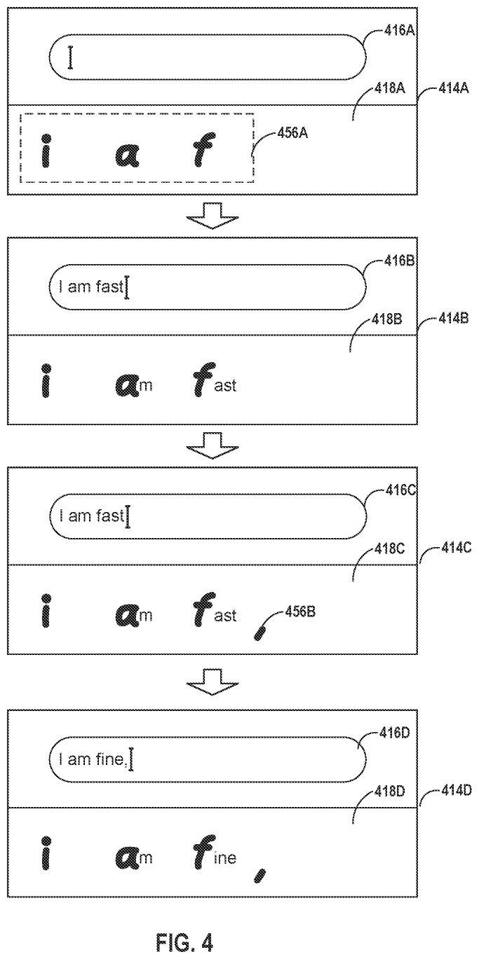

FIG. 4 is a conceptual diagram illustrating an example technique for providing additional context to a language model to determine a series of candidate words, in accordance with aspects of the present disclosure. For purposes of illustration only, FIG. 4 is described herein within the context of computing device 202 of FIG. 2.

As shown in FIG. 4, UID 204 of computing device 202 may display user interface 414A that includes text input field 416A and text input interface 418A. Text input interface 418A may be a portion of user interface 414A within which the user may interact to provide handwriting input to input text that may be inserted into text input field 416A.

The user of computing device 202 may attempt to input an intended sequence of words into text input field 416A by interacting with UID 204 to input a sequence of word abbreviations that correspond to the intended sequence of words. For example, the user of computing device 202 may interact with UID 204 to provide, at a location of user interface 414A that corresponds to text input interface 418A, handwriting input 456A that corresponds to the sequence of word abbreviations. In the example of FIG. 4, a word abbreviation for a word is the initial character for the word, and the user may therefore be able to input the sequence of word abbreviations as a sequence of characters, such as “iaf”. As such, the user may input a sequence of word abbreviations as a sequence of characters by providing handwriting input 456A that includes a sequence of handwritten characters, such as a first handwritten character “i”, followed by a second handwritten character “a”, followed by a third handwritten character “f”.

Computing device 202 may use language model 208 to determine a sequence of candidate words that correspond to the sequence of word abbreviations inputted via handwriting input 456A. In the example where each word abbreviation is a single character, the sequence of word abbreviations may be a sequence of characters that correspond to handwriting input 456A, and computing device 202 may use language model 208 to determine a sequence of candidate words having a sequence of initial characters that correspond to the sequence of characters making up the sequence of word abbreviations. For example, given the sequence of word abbreviations “i”, “a”, and “f” inputted via handwriting input 456A, computing device 202 may use language model 208 to determine that a sequence of candidate words “I am fast” corresponds to the sequence of word abbreviations.

Computing device 202 may, in response to determining a sequence of candidate words that correspond to the sequence of word abbreviations, output the sequence of candidate words for display at UID 204. For example, computing device 202 may output, at UID 204, user interface 414B, which corresponds to user interface 414A and includes text input field 416B that corresponds to text input field 416A and text input interface 418B that corresponds to text input interface 418A, to present the sequence of candidate words “I am fast” in text input interface 418B of user interface 414B. In some examples, computing device 202 may also input the sequence of candidate words “I am fast” into text input field 416B.

In some examples, after computing device 202 determines and outputs a sequence of candidate words that corresponds to the inputted sequence of word abbreviations, the user may provide further context in the form of a punctuation mark, such as a comma, a period, a question mark, an exclamation mark, and the like, to enable language model 208 to determine an updated sequence of candidate words. In the example of FIG. 4, computing device 202 may output, at UID 204, user interface 414C, which corresponds to user interface 414B, and includes text input field 416C that corresponds to text input field 416B and text input interface 418C that corresponds to text input interface 418B, to present, in text input field 416, the sequence of candidate words “i am fast” that corresponds to the sequence of word abbreviations “i”, “a”, and “f”.

The user may interact with UID 204 to provide handwriting input 456B that includes a comma after the sequence of candidate words “I am fast” in user interface 414C, and computing device 202 may use language model 208 to determine, based at least in part on the sequence of word abbreviations and information regarding the inputted punctuation mark, such as the type of punctuation mark, the location of the punctuation mark in user interface 414C with respect to the previously-determined candidate word, a sequence of candidate words having a sequence of initial characters that correspond to the sequence of word abbreviations and the inputted punctuation mark. For example, given the sequence of word abbreviations “i”, “a”, and “f” and the inputted comma, computing device 202 may use language model 208 to determine that a sequence of candidate words “I am fine” followed by “,” corresponds to the sequence of word abbreviations.

Computing device 202 may, in response to determining a sequence of candidate words, output the sequence of candidate words for display at UID 204. For example, computing device 202 may update user interface 414C by outputting user interface 414D, which corresponds to user interface 414C, to present the sequence of candidate words “I am fine” followed by “,” in text input interface 418D of user interface 414D. In some examples, computing device 202 may also input the sequence of candidate words “I am fine” followed by “,” into text input field 416D of user interface 414D.

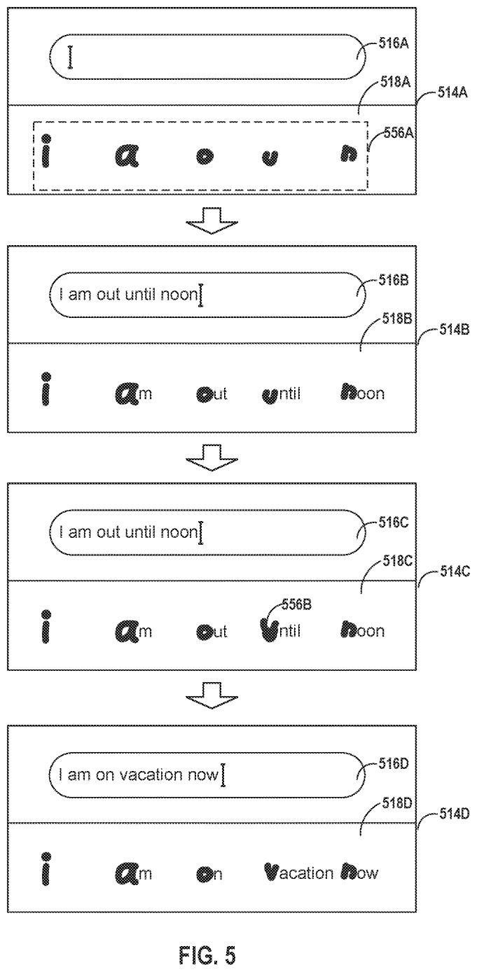

FIG. 5 is a conceptual diagram illustrating an example technique for providing additional context to a language model to determine a series of candidate words, in accordance with aspects of the present disclosure. For purposes of illustration only, FIG. 5 is described herein within the context of computing device 202 of FIG. 2.

As shown in FIG. 5, UID 204 of computing device 202 may display user interface 514A that includes text input field 516A and text input interface 518A. Text input interface 518A may be a portion of user interface 514A within which the user may interact to provide handwriting input to input text that may be inserted into text input field 516A.

The user of computing device 202 may attempt to input an intended sequence of words into text input field 516A by interacting with UID 204 to input a sequence of word abbreviations that correspond to the intended sequence of words. For example, the user of computing device 202 may interact with UID 204 to provide, at a location of user interface 514A that corresponds to text input interface 518A, handwriting input 556A that corresponds to the sequence of word abbreviations. In the example of FIG. 5, a word abbreviation for a word is the initial character for the word, and the user may therefore be able to input the sequence of word abbreviations as a sequence of characters, such as “iaoun”. As such, the user may input a sequence of word abbreviations as a sequence of characters by providing handwriting input 556A that includes a sequence of handwritten characters, such as a first handwritten character “i”, followed by a second handwritten character “a”, followed by a third handwritten character “o”, followed by a fourth handwritten character “u”, followed by a fifth handwritten character “n.

Computing device 202 may use language model 208 to determine a sequence of candidate words that correspond to the sequence of word abbreviations inputted via handwriting input 556A. In the example where each word abbreviation is a single character, the sequence of word abbreviations may be a sequence of characters that correspond to handwriting input 556A, and computing device 202 may use language model 208 to determine a sequence of candidate words having a sequence of initial characters that correspond to the sequence of characters making up the sequence of word abbreviations. For example, given the sequence of word abbreviations “i”, “a”, “o”, “u”, and “n” inputted via handwriting input 556A, computing device 202 may use language model 208 to determine that a sequence of candidate words “I am out until noon” corresponds to the sequence of word abbreviations.

Computing device 202 may, in response to determining a sequence of candidate words that correspond to the sequence of word abbreviations, output the sequence of candidate words for display at UID 204. For example, computing device 202 may update user interface 514A by outputting, for display at UID 204, user interface 514B that corresponds to 514A, to present the sequence of candidate words “I am out until noon” in text input interface 518B of user interface 514B. In some examples, computing device 202 may also input the sequence of candidate words “I am out until noon” into text input field 516B of user interface 514B.

If a user has made an error in entering the sequence of word abbreviations, the user may be able to fix the error by providing user input at UID 204 to edit the sequence of candidate words outputted by UID 204. For example, computing device 202 may output user interface 514C, which corresponds to user interface 514B, that includes text input field 516C and text input interface 518C that the sequence of candidate words “I am out until noon” corresponding to the sequence of word abbreviations “i”, “a”, “o”, “u”, and “n”. The user may therefore be able to interact with UID 204 to edit the sequence of candidate words presented in user interface 514C.

For example, if the user had intended to input the character “v” as the sequentially third word abbreviation in the sequence of word abbreviations but made a mistake by inputting the character “u”, the user may be able to directly edit the sequence of candidate words presented in user interface 514C to replace the word abbreviation “u” with the inputted character “v”. To replace the character the word abbreviation “u” with the inputted character “v”, the user may hand write the character “v” over the character “u” in the candidate word “until” in user interface 514C to replace the character “u” with the character “v”. That is, the user may interact with UID 204 to provide handwritten input 558B that includes handwritten character “v” at a location of user interface 514C that corresponds to the location of the character “u”, which may be a location of user interface 514C that at least partially overlaps the character “u” presented in user interface 514.

Computing device 202 may therefore replace the corresponding word abbreviation “u” with the word abbreviation “v” in the sequence of word abbreviations to update the sequence of word abbreviations to “i”, “a”, “o”, “v”, and “n”, and may use language model 208 to determine a sequence of candidate words that correspond to the updated sequence of word abbreviations. For example, given the sequence of word abbreviations “i”, “a”, “o”, “v”, and “n”, computing device 202 may use language model 208 to determine that a sequence of candidate words “I am on vacation now” corresponds to the sequence of word abbreviations.

Computing device 202 may, in response to determining a sequence of candidate words that correspond to the sequence of word abbreviations, output the sequence of candidate words for display at UID 204. For example, computing device 202 may update user interface 514C by outputting user interface 514D that corresponds to 514C, to present the sequence of candidate words “I am on vacation now” in text input interface 518D of user interface 514D. In some examples, computing device 202 may also input the sequence of candidate words “I am on vacation now” into text input field 516D of user interface 514D.

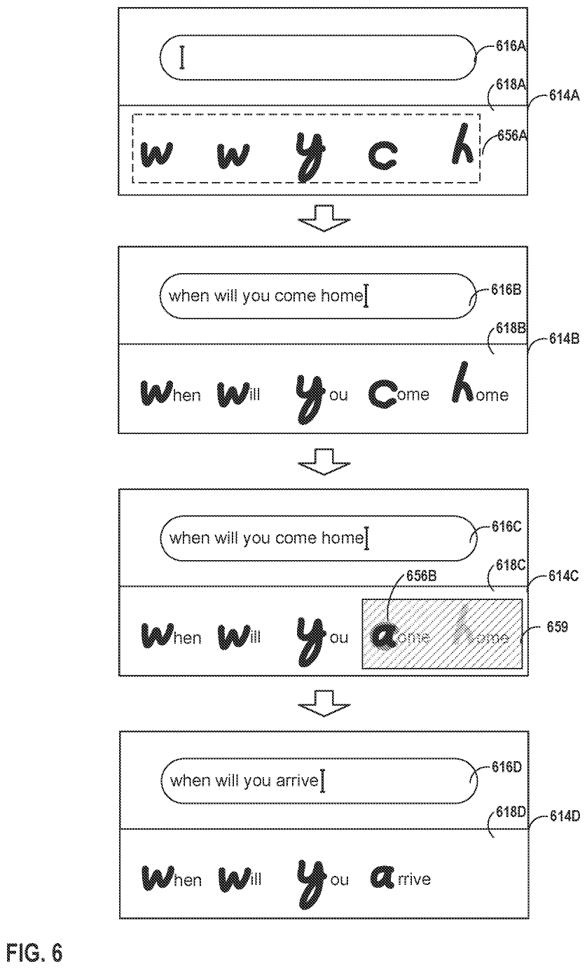

FIG. 6 is a conceptual diagram illustrating techniques for editing one or more candidate words, in accordance with aspects of the present disclosure. For purposes of illustration only, FIG. 6 is described herein within the context of computing device 202 of FIG. 2.

As shown in FIG. 6, UID 204 of computing device 202 may display user interface 614A that includes text input field 616A and text input interface 618A. Text input interface 618A may be a portion of user interface 614A within which the user may interact to provide handwriting input to input text that may be inserted into text input field 616A.

The user of computing device 202 may interact with UID 204 to input an intended sequence of words into text input field 616A by inputting a sequence of word abbreviations that correspond to the intended sequence of words. For example, the user of computing device 202 may interact with UID 204 to provide, at a location of user interface 614A that corresponds to text input interface 618, handwriting input 656A that corresponds to the sequence of word abbreviations. In the example of FIG. 6, a word abbreviation for a word is the initial character for the word, and the user may therefore be able to input the sequence of word abbreviations as a sequence of characters, such as “wwych”. As such, the user may input a sequence of word abbreviations as a sequence of characters by providing handwriting input 656A that includes a sequence of handwritten characters, such as a first handwritten character “w”, followed by a second handwritten character “w”, followed by a third handwritten character “y”, followed by a fourth handwritten character “c”, followed by a fifth handwritten character “h”.

Computing device 202 may use language model 208 to determine a sequence of candidate words that correspond to the sequence of word abbreviations inputted via handwriting input 656A. In the example where each word abbreviation is a single character, the sequence of word abbreviations may be a sequence of characters that correspond to handwriting input 656A, and computing device 202 may use language model 208 to determine a sequence of candidate words having a sequence of initial characters that correspond to the sequence of characters making up the sequence of word abbreviations. For example, given the sequence of word abbreviations “w”, “w”, “y”, “c”, and “h” inputted via handwriting input 656A, computing device 202 may use language model 208 to determine that a sequence of candidate words “when will you come home” corresponds to the sequence of word abbreviations.

Computing device 202 may, in response to determining a sequence of candidate words that correspond to the sequence of word abbreviations, output the sequence of candidate words for display at UID 204. For example, computing device 202 may update user interface 614A by outputting user interface 614B that corresponds to user interface 614A to present the sequence of candidate words “when will you come home” in text input interface 618B of user interface 614B. In some examples, computing device 202 may also input the sequence of candidate words “when will you come home” into text input field 616B.

The user of computing device 202 may interact with UID 204 to select a plurality of candidate words from the sequence of candidate words presented in user interface 614B. For example, the user may perform one or more gestures at UID 204, such as one or more drag gesture, a long hold gesture, a double tap gesture, or any combination thereof, to input, at UID 204, a user input that corresponds to selecting of two or more candidate words from the sequence of candidate words.

In the example of FIG. 6, the user may provide user input at UID 204 to select the candidate words “come home”. Computing device 202 may, in response to receiving the user input that corresponds to selection of the candidate words “come home” from the sequence of candidate words presented in user interface 614B, output a visual indication of the selected candidate words “come home.” For example, computing device 202 may output user interface 614C, which corresponds to user interface 614B, that includes a visual indication of the selected candidate words “come home”. Specifically, user interface 614C may include text field 616C and text input interface 618C that includes the candidate word “when will you come home” that corresponds to the sequence of word abbreviations “w”, “w”, “y”, “c”, and “h”, and user interface 614C may also include visual indication 659 of the selected candidate words “come home”. Such visual indication 659 of the selected candidate words “come home” may, in some examples, be in the form of highlighting the selected candidate words.

The user may edit the selected candidate words by providing an additional handwriting input at UID 204 to input one or more characters that overlap at least a portion of the selected candidate words in user interface 614C. Inputting one or more characters that overlap at least a portion of the selected candidate words in user interface 614C may cause computing device 202 to replace the selected candidate words with a replacement candidate word that corresponds with the inputted one or more characters, such as a replacement candidate word having the inputted characters as the replacement candidate word's initial one or more characters, a replacement candidate word having a subsequence of the inputted one or more characters, and the like. In some examples, computing device 202 may replace the selected candidate words with a replacement candidate word that corresponds with the inputted one or more characters by replacing the word abbreviations that correspond to the selected candidate words in the sequence of word abbreviations with a new word abbreviation that is the one or more word abbreviations.

The user of computing device 202 may therefore interact with UID 204 to provide handwriting input 656B, which corresponds to the character “a”, at a location of user interface 614C that corresponds to the selected candidate words “come home”. The location of handwriting input 656A in user interface 614C may correspond to the selected candidate words “come home” in user interface 614C by overlapping at least a portion of the selected candidate words “come home” in user interface 614C or by overlapping at least a portion of the initial character “c” of the selected candidate words “come home” in user interface 614C.

Computing device 202 may receive an indication of handwriting input 656A having a location in user interface 614C that corresponds to the selected candidate words “come home” and may, in response, replace the word abbreviations “c” and “h” that correspond to the selected candidate words “come home” in the sequence of word abbreviations associated with the sequence of candidate words with a new word abbreviation of “a”, which is the character that corresponds to handwriting input 656B. By replacing the word abbreviations “c” and “h” in the sequence of word abbreviations associated with the sequence of candidate words with a new word abbreviation of “a”, computing device generates a new sequence of word abbreviations “w”, “w”, “y”, “a”, and computing device 202 may use language model 208 to determine new sequence of candidate words that correspond to the new sequence of word abbreviations. For example, computing device 202 may use language model 208 to determine a new sequence of candidate words having a sequence of initial characters that correspond to the new sequence of word abbreviations.

In the example of FIG. 6, and computing device 202 may use language model 208 to determine a new sequence of candidate words “when will you arrive” that corresponds to the new sequence of word abbreviations “w”, “w”,“y”, “a”, and may output the new sequence of candidate words for display at UID 204. For example, computing device 202 may update user interface 614C by outputting user interface 614D that corresponds to user interface 614C to present the sequence of candidate words “when will you arrive” in text input interface 618D of user interface 614D. In some examples, computing device 202 may also input the sequence of candidate words “when will you arrive” into text input field 616D.

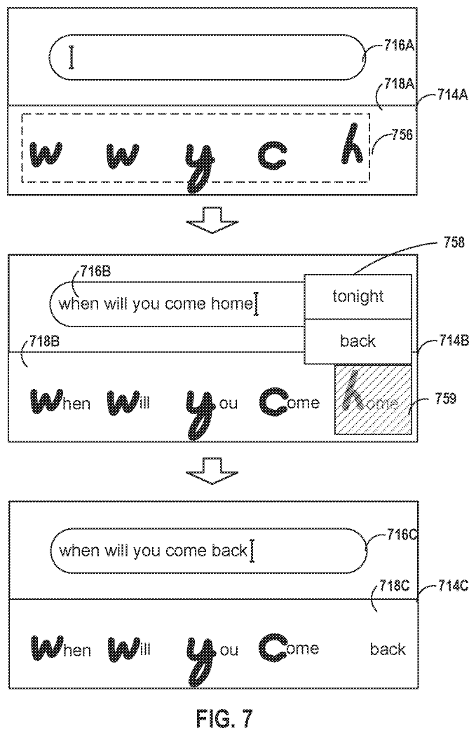

FIG. 7 is a conceptual diagram illustrating techniques for replacing one or more candidate words, in accordance with aspects of the present disclosure. For purposes of illustration only, FIG. 7 is described herein within the context of computing device 202 of FIG. 2.

As shown in FIG. 7, UID 204 of computing device 202 may display user interface 714A that includes text input field 716A and text input interface 718A. Text input interface 718A may be a portion of user interface 714A within which the user may interact to provide handwriting input to input text that may be inserted into text input field 716A.

The user of computing device 202 may attempt to input an intended sequence of words into text input field 716A by interacting with UID 204 to input a sequence of word abbreviations that correspond to the intended sequence of words. For example, the user of computing device 202 may interact with UID 204 to provide, at a location of user interface 714A that corresponds to text input interface 718A, handwriting input 756 that corresponds to the sequence of word abbreviations. In the example of FIG. 7, a word abbreviation for a word is the initial character for the word, and the user may therefore be able to input the sequence of word abbreviations as a sequence of characters, such as “wwych”. As such, the user may input a sequence of word abbreviations as a sequence of characters by providing handwriting input 756 that includes a sequence of handwritten characters, such as a first handwritten character “w”, followed by a second handwritten character “w”, followed by a third handwritten character “y”, followed by a fourth handwritten character “c”, followed by a fifth handwritten character “h”.

Computing device 202 may use language model 208 to determine a sequence of candidate words that correspond to the sequence of word abbreviations inputted via handwriting input 756. In the example where each word abbreviation is a single character, the sequence of word abbreviations may be a sequence of characters that correspond to handwriting input 756, and computing device 202 may use language model 208 to determine a sequence of candidate words having a sequence of initial characters that correspond to the sequence of characters making up the sequence of word abbreviations. For example, given the sequence of word abbreviations “w”, “w”, “y”, “c”, and “h” inputted via handwriting input 756, computing device 202 may use language model 208 to determine that a sequence of candidate words “when will you come home” corresponds to the sequence of word abbreviations.

Computing device 202 may, in response to determining a sequence of candidate words that correspond to the sequence of word abbreviations, output the sequence of candidate words for display at UID 204. For example, computing device 202 may update user interface 714A by outputting user interface 714B that corresponds to user interface 714A to present the sequence of candidate words “when will you come home” in text input interface 718B of user interface 714B. In some examples, computing device 202 may also input the sequence of candidate words “when will you come home” into text input field 716B.

The user of computing device 202 may interact with UID 204 to select a candidate from the sequence of candidate words presented in user interface 714B. For example, the user may perform one or more gestures at UID 204, such as one or more drag gesture, a long hold gesture, a double tap gesture, or any combination thereof, to input, at UID 204, a user input that corresponds to selecting a candidate word from the sequence of candidate words presented in user interface 714B.

In the example of FIG. 7, the user may provide user input at UID 204 to select the candidate word “home”. Computing device 202 may, in response to receiving the user input that corresponds to selection of a candidate word “home” from the sequence of candidate words “when will you come home” in user interface 714B, output a visual indication of the selected candidate word “home”. For example, computing device 202 may output user interface 714C, which corresponds to user interface 714B, that includes a visual indication of the selected candidate word “home”. Specifically, user interface 714C may include text input field 716C and text input interface 718C that includes the candidate word “when will you come home” that corresponds to the sequence of word abbreviations “w”, “w”, “y”,“c”, and “h”, and user interface 714C may also include visual indication 759 of the selected candidate word “home”. Such visual indication 759 of the selected candidate “home” may, in some examples, be in the form of highlighting the selected candidate word.

Computing device 202 may, in response to receiving the user input that corresponds to selection of a candidate word from the sequence of candidate words, also determine, using language model 208, one or more suggested replacement words to replace the selected candidate word. Computing device 202 may use language model 208 to determine one or more words that are most likely to be selected by the user as the suggested replacement word in place of the candidate word in the sequence of candidate words

Computing device 202 may, in response to determining one or more suggested replacement words, present the one or more suggested replacement words in user interface 714C, and a user of computing device 202 may provide user input at UID 204 to interact with user interface 714C to select one of the one or more suggested replacement word as the replacement word for the selected candidate word. For example, computing device 202 may determine the words “tonight” and “back” as two suggested replacement words for replacing the selected candidate word “home”, and computing device 202 may present the two suggested replacement words in a user interface element, such as menu 758, in user interface 714C.

A user may interact with UID 204 to provide user input that corresponds to selection of the suggested replacement word “back” in menu 758. Computing device 202 may, in response to receiving an indication of the user input that corresponds to selection of the suggested replacement word “back”, update the sequence of candidate words by replacing the selected candidate word “home” with the selected suggested replacement word “back.” That is, computing device 202 may therefore update the sequence of candidate words “when will you come home” by replacing the selected candidate word “home” with the suggested replacement word “back” to form the updated sequence of candidate words “when will you come back”.

Computing device 202 may therefore output user interface 714D, which corresponds with user interface 714C, to present the updated sequence of candidate words “when will you come back,” such as presenting the updated sequence of candidate words in text input interface 718D. Computing device 202 may also input the updated sequence of candidate words into text input field 716D.

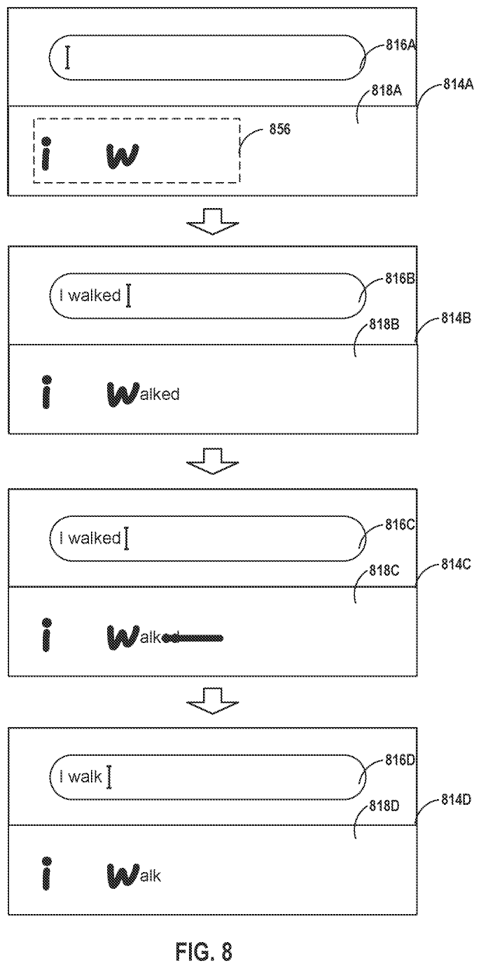

FIG. 8 is a conceptual diagram illustrating techniques for editing one or more candidate words, in accordance with aspects of the present disclosure. For purposes of illustration only, FIG. 8 is described herein within the context of computing device 202 of FIG. 2.

As shown in FIG. 8, UID 204 of computing device 202 may display user interface 814A that includes text input field 816A and text input interface 818A. Text input interface 818A may be a portion of user interface 814A within which the user may interact to provide handwriting input to input text that may be inserted into text input field 816A.

The user of computing device 202 may attempt to input an intended sequence of words into text input field 816A by interacting with UID 204 to input a sequence of word abbreviations that correspond to the intended sequence of words. For example, the user of computing device 202 may interact with UID 204 to provide, at a location of user interface 814A that corresponds to text input interface 818A, handwriting input 856 that corresponds to the sequence of word abbreviations. In the example of FIG. 8, a word abbreviation for a word is the initial character for the word, and the user may therefore be able to input the sequence of word abbreviations as a sequence of characters, such as “wi”. As such, the user may input a sequence of word abbreviations as a sequence of characters by providing handwriting input 856 that includes a sequence of handwritten characters, such as a first handwritten character “i” followed by a second handwritten character “w”.

Computing device 202 may use language model 208 to determine a sequence of candidate words that correspond to the sequence of word abbreviations inputted via handwriting input 856. In the example where each word abbreviation is a single character, the sequence of word abbreviations may be a sequence of characters that correspond to handwriting input 856, and computing device 202 may use language model 208 to determine a sequence of candidate words having a sequence of initial characters that correspond to the sequence of characters making up the sequence of word abbreviations. For example, given the sequence of word abbreviations “w” and “w” inputted via handwriting input 856, computing device 202 may use language model 208 to determine that a sequence of candidate words “we walked” corresponds to the sequence of word abbreviations.

Computing device 202 may, in response to determining a sequence of candidate words that correspond to the sequence of word abbreviations, output the sequence of candidate words for display at UID 204. For example, computing device 202 may update user interface 814A by outputting user interface 814A, which corresponds to user interface 814B, to present the sequence of candidate words “i walked” in text input interface 818B of user interface 814B. In some examples, computing device 202 may also input the sequence of candidate words “i walked” into text input field 816B.

A user may interact with UID 204 to provide gesture input, such as a gesture input crossing out a sequence of one or more characters, to delete the sequence of one or more characters, such as one or more handwritten characters inputted by the user or one or more characters of a candidate word. For example, the user may, after providing handwriting input to input a handwritten character, provide a gesture input to cross out the handwritten character in order to delete the handwritten character. The user may, after deleting the previously inputted handwritten character, be able to provide handwriting input to input another handwritten character in place of the deleted handwritten character.

In the example of FIG. 8, computing device 202 may output, for display by UID 204, user interface 814C, which corresponds to user interface 814B and includes text input field 816C and text input interface 818C, that presents the sequence of candidate words “we walked”, and the user may provide a gesture input crossing out a sequence of one or more characters, such as one or more characters of a candidate word presented in user interface 814C. Computing device 202 may, in response to receiving an indication of the gesture input crossing out one or more characters of the sequence of candidate words in user interface 814C, delete the one or more characters crossed out by the gesture input.

For example, the user may interact with UID 204 to provide gesture input crossing out the sequence of characters “ed” at the end of the candidate word “walked” presented in user interface 814C. Computing device 202 may receive an indication of the gesture input crossing out the sequence of characters “ed” at the end of the candidate word “walked” and may, in response, delete the sequence of characters “ed” from the candidate word “walked” to generate a new sequence of candidate words “we walk”.

In some examples, instead of merely deleting the crossed out sequence of characters from a candidate word, computing device 202 may use the deleted sequence of characters as an additional constraint when determining, using language model 208, a new sequences of candidate words that correspond to the sequence of word abbreviations inputted via handwriting input 856. For example, computing device 202 may, in response to deleting the sequence of characters “ed” from the candidate word “walked” that corresponds to the word abbreviation “w” in the sequence of word abbreviations “i” and “w”, determine a new sequence of candidate words that correspond to the same sequence of word abbreviations by constraining the candidate word that corresponds to the word abbreviation “w” in the new sequence of candidate words to be a word that does not include the deleted sequence of characters “ed”.

Computing device 202 may, in response to deleting the sequence of characters “ed” from the candidate word “walked”, determine a new sequence of candidate words “I walk”. Computing device 202 may therefore output the new sequence of candidate words “I walked at UID 204. For example, computing device 202 may output, for display at UID 204, user interface 814D, which corresponds to user interface 814C, to present the new sequence of candidate words “I walk,” such as presenting the new sequence of candidate words in text input interface 818D. Computing device 202 may also input the new sequence of candidate words into text input field 816D.

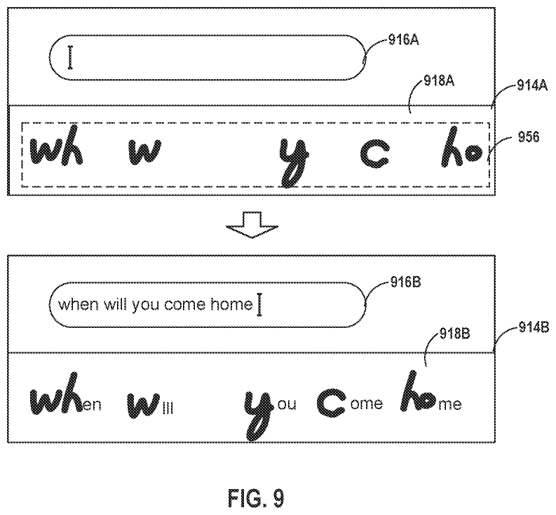

FIG. 9 is a conceptual diagram illustrating techniques for determining a sequence of abbreviated words in a sequence of characters, in accordance with aspects of the present disclosure. For purposes of illustration only, FIG. 8 is described herein within the context of computing device 202 of FIG. 2.

As shown in FIG. 9, UID 204 of computing device 202 may display user interface 914A that includes text input field 916A and text input interface 918A. Text input interface 918A may be a portion of user interface 914A within which the user may interact to provide handwriting input to input text in a text input field, such as text input field 916A. In examples where UID 204 includes a touchscreen that displays user interface 914A, the user may interact with a portion of the touchscreen of UID 204 that corresponds to text input interface 918A to provide handwriting input in the portion of the touchscreen that corresponds to text input interface 918A.

The user of computing device 202 may attempt to input an intended sequence of words into text input field 916A by interacting with UID 204 to input a sequence of word abbreviations that correspond to the intended sequence of words. For example, the user of computing device 202 may interact with UID 204 to provide, at a location of user interface 914A that corresponds to text input interface 918A, handwriting input 956 that corresponds to the sequence of word abbreviations. That is, the user may provide handwriting input 956 of a sequence of handwritten characters that correspond to the sequence of characters in the sequence of word abbreviations.

In the example of FIG. 9, each word abbreviation in the sequence of word abbreviations is a variable length prefix of a corresponding word, meaning that each word abbreviation is a sequence of one or more characters at the start of a corresponding word. For instance, a word that corresponds to a word abbreviation that is a sequence of two characters may include the sequence of two characters of the corresponding word abbreviation as the first two characters of the word. Because word abbreviations in the sequence of word abbreviations may each be a sequence of one or more characters, each word abbreviation in the sequence of word abbreviations may not necessarily be of the same length.

The user may provide handwriting input 956 to input a sequence of handwritten characters in ways that groups together the handwritten characters of the same word abbreviation and spaces apart handwritten characters of different abbreviations.

Specifically, the user may input handwritten characters that are part of the same word abbreviation close to each other, while leaving a space between handwritten characters of two separate word abbreviations, such as by spacing apart a handwritten character the last character of a sequence characters making up a word abbreviation and the next handwritten character that is the first character of another sequence of word abbreviations.

In the example of FIG. 9, handwriting input 956 includes the sequence of handwritten characters “w”, “h”, “w”, “y”,“c”, “h”, and “o”. As can be seen, the sequence of handwritten characters “w” and “h” are grouped together and spaced apart from the next handwritten character “w”, which is spaced apart from the next handwritten character “y”, which is spaced apart from the next handwritten character “c”, which is spaced apart from the next sequenced of handwritten characters “h” and “o”, which are grouped together. In this way, handwriting input 956 may indicate that the sequence of word abbreviations in the sequence of handwritten characters are “wh”, “w”, “y”, “c”, and “ho”.

Computing device 202 may therefore be able to determine a sequence of word abbreviations included in the sequence of handwritten characters based at least in part on the locations of each of the handwritten characters in user interface 914A and the distances between the locations of each of the handwritten characters in user interface 914A. For example, computing device 202 may determine, for each handwritten character, the distance between the location of the handwritten character and the location of neighboring handwritten characters in the sequence of handwritten characters provided by the user. In this way, computing device 202 may determine that the sequence of word abbreviations in the sequence of handwritten characters are “wh”, “w”, “y”,“c” and “ho”.

Computing device 202 may use language model 208 to determine a sequence of candidate words that correspond to the sequence of word abbreviations inputted via handwriting input 956. In the example where each word abbreviation in the sequence of word abbreviations is a variable length prefix of a corresponding word, computing device 202 may use language model 208 to determine a sequence of candidate words, where each candidate word includes the corresponding word abbreviation as the initial characters of the candidate word. For example, given the sequence of word abbreviations “wh”, “w”, “y”, “c”, and “ho” inputted via handwriting input 956, computing device 202 may use language model 208 to determine that a sequence of candidate words “when will you come home” corresponds to the sequence of word abbreviations.

Computing device 202 may, in response to determining a sequence of candidate words that correspond to the sequence of word abbreviations, output the sequence of candidate words for display at UID 204. For example, computing device 202 may update user interface 914A by outputting user interface 914B, which corresponds to user interface 914A, to present the sequence of candidate words “when will you come home” in text input interface 918B of user interface 914B. In some examples, computing device 202 may also input the sequence of candidate words “when will you come home” into text input field 916B.

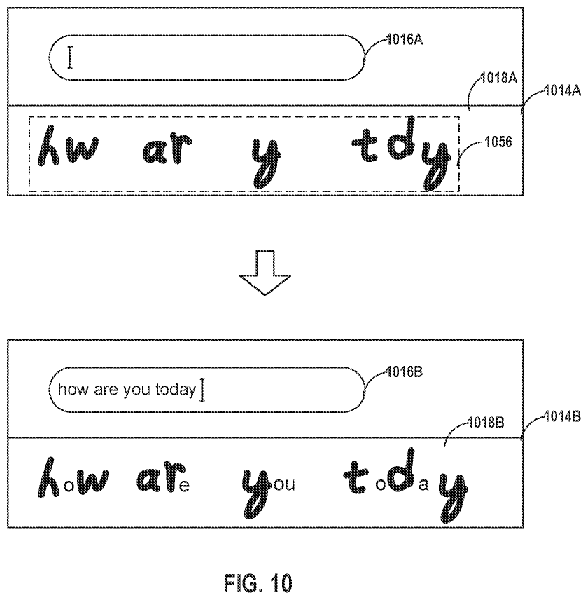

FIG. 10 is a conceptual diagram illustrating techniques for determining a sequence of abbreviated words in a sequence of characters, in accordance with aspects of the present disclosure. For purposes of illustration only, FIG. 10 is described herein within the context of computing device 202 of FIG. 2.

As shown in FIG. 10, UID 204 of computing device 202 may display user interface 1014A that includes text input field 1016A and text input interface 1018A. Text input interface 1018A may be a portion of user interface 1014A within which the user may interact to provide handwriting input to input text in a text input field, such as text input field 1016A. In examples where UID 204 includes a touchscreen that displays user interface 1014A, the user may interact with a portion of the touchscreen of UID 204 that corresponds to text input interface 1018A to provide handwriting input in the portion of the touchscreen that corresponds to text input interface 1018A.

The user of computing device 202 may attempt to input an intended sequence of words into text input field 1016A by interacting with UID 204 to input a sequence of word abbreviations that correspond to the intended sequence of words. For example, the user of computing device 202 may interact with UID 204 to provide, at a location of user interface 1014A that corresponds to text input interface 1018A, handwriting input 1056 that corresponds to the sequence of word abbreviations. That is, the user may provide handwriting input 1056 of a sequence of handwritten characters that correspond to the sequence of characters in the sequence of word abbreviations.

In the example of FIG. 10, each word abbreviation in the sequence of word abbreviations is a subsequence of a corresponding word, meaning that a sequence of characters in a word abbreviation appear in the same order in the corresponding word but are not necessarily contiguous characters in the corresponding word. Further, each word abbreviation includes, as the initial character of the word abbreviation, the initial character of the corresponding word. For word abbreviations that are sequences of multiple characters, the initial character of the corresponding word may include one or more consonants of the corresponding word. That is, only the initial character of a word abbreviation may include a vowel, and any medial characters and final characters in a word abbreviation may include only consonants.

The user may provide handwriting input 1056 to indicate that the sequence of word abbreviations in the sequence of handwritten characters are “hw”, “ar”, “y”, and “tdy”, and computing device 202 may use language model 208 to determine a sequence of candidate words that correspond to the sequence of word abbreviations inputted via handwriting input 1056. In the example where each word abbreviation includes the initial character of a corresponding word and any subsequent characters of the word abbreviation may only include consonants, computing device 202 may use language model 208 to determine a sequence of candidate words, where each candidate word includes the initial character of the corresponding word abbreviation as the initial character of the candidate word, and includes, in order, any remaining characters in the corresponding word abbreviation. For example, given the sequence of word abbreviations “hw”, “ar”, “y”, and “tdy” inputted via handwriting input 1056, computing device 202 may use language model 208 to determine that a sequence of candidate words “how are you today” corresponds to the sequence of word abbreviations.

Computing device 202 may, in response to determining a sequence of candidate words that correspond to the sequence of word abbreviations, output the sequence of candidate words for display at UID 204. For example, computing device 202 may update user interface 1014A by outputting user interface 1014B that corresponds to user interface 1014A to present the sequence of candidate words “how are you today” in text input interface 1018B of user interface 1014B. In some examples, computing device 202 may also input the sequence of candidate words “how are you today” into text input field 1016B.

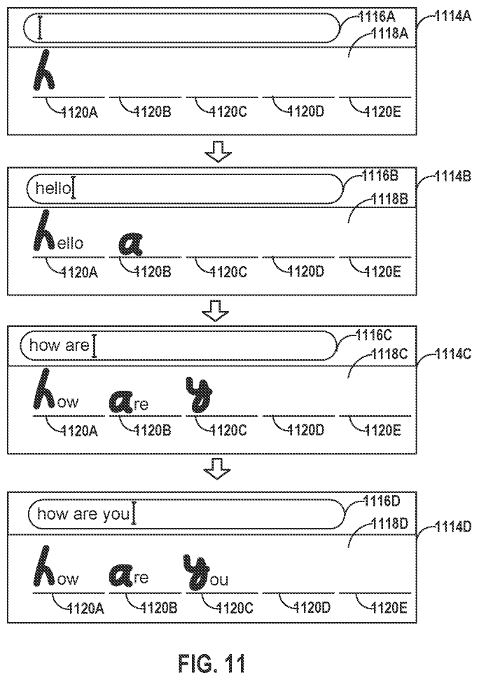

FIG. 11 is a conceptual diagram illustrating an example user interface for determining a sequence of candidate words, in accordance with aspects of the present disclosure. For purposes of illustration only, FIG. 11 is described herein within the context of computing device 202 of FIG. 2.

As shown in FIG. 11, UID 204 of computing device 202 may display user interface 1114A that includes text input field 1116A and text input interface 1118A. Text input interface 1118A may be a portion of user interface 1114A within which the user may interact to provide handwriting input to input text that may be inserted into text input field 1116A.

Text input interface 1118A may include a sequence of word input fields 1120A-1120E (“word input fields 1120”). While text input interface 1118A includes five word input fields 1120, text input interface 1118A may, in other examples, include a sequence of any number of word input fields. Each word input field of word input fields 1120 may visually define a respective non-overlapping portion of user interface 1114A within which the user of computing device 202 may provide handwritten input of one or more characters.

Word input fields 1120 may be in an ordered sequence according to the writing direction of the language of the handwritten input. In the example of FIG. 11 where UID 204 receives handwritten input in the English language having a left-to-right writing direction, the sequence of word input fields 1120 may be presented in an ordered horizontal direction in user interface 1114A from left to right.

The order of the sequence of word input fields 1120 may correspond to the order of a sequence of words, such that each world input field corresponds to a respective word position in a sequence of words. For example, the first word input field 1120A in the sequence of word input fields 1120 may correspond to the sequentially first word in the sequence of words, the second word input field 1120B in the sequence of word input fields 1120 may correspond to the sequentially second word in the sequence of words, the third word input field 1120C in the sequence of word input fields 1120 may correspond to the sequentially third word in the sequence of words, the fourth word input field 1120D in the sequence of word input fields 1120 may correspond to the sequentially fourth word in the sequence of words, and the fifth word input field 1120E in the sequence of word input fields 1120 may correspond to the sequentially fifth word in the sequence of words.

Because the order of the sequence of word input fields 1120 corresponds to the order of a sequence of words, a user may interact with UID 204 to input a word abbreviation for a word in a given position in a sequence of words at the world input field in a given position in word input fields 1120 that corresponds to the given position of the word in the sequence of words. In the example of FIG. 11, if the user intends to input a sequence of word abbreviations “h”, “a”, and “y” for an intended sequence of words “how are you,” the user may input “h” in first word input field 1120A that corresponds to a sequentially first word position in a sequence of words, input “a” in word input field 1120B that corresponds to a sequentially second word position in a sequence of words, and may input “y” in word input field 1120C that corresponds to a sequentially third word position in a sequence of words,

The user may interact with UID 204 to provide handwriting input that includes handwritten character “h” at a location of user interface 1114A that corresponds to first word input field 1120A in order to input the word abbreviation for a first word in a sequence of words. In response, computing device 202 may use language model 208 to determine a candidate word that corresponds to the word abbreviation “h” inputted within the portion of user interface 1114A. For example, given the handwritten character “h” inputted in first word input field 1120A, computing device 202 may use language model 208 to determine a candidate word “hello” corresponds to the word abbreviation “h”.

Computing device 202 may, in response to determining the candidate word, output the candidate word for display at UID 204. For example, computing device 202 may update user interface 1114A by outputting user interface 1114B, which corresponds to user interface 1114A, and which includes text input field 1116B and text input interface 1118B that includes word input fields 1120, to present the candidate word “hello” in the portion of user interface 1114B that corresponds to first word input field 1120A. In some examples, computing device 202 may also input candidate word “hello” into text input field 1116B.

After the user has written the character “h” in first word input field 1120A, the user may interact with UID 204 to provide handwriting input that includes handwritten character “a” at a location of user interface 1114B that corresponds to second word input field 1120B in order to input the word abbreviation for a second word in a sequence of words. Because the user had previously inputted the character “h” in first word input field 1120A, the sequence of word abbreviations is now “h” and “a”.

In response, computing device 202 may use language model 208 to determine a sequence of candidate words that correspond to the sequence of word abbreviations “h” and “a” inputted within word input fields 1120A and 1120B. For example, given the handwritten character “h” inputted in first word input field 1120A and the handwritten character “a” inputted in second word input field 1120B, computing device 202 may use language model 208 to determine a candidate word “how are” corresponds to the sequence of word abbreviation “h” and “a”.

Computing device 202 may, in response to determining the sequence of candidate words, output the candidate word for display at UID 204. For example, because the computing device has determined “how” as the first candidate word in the sequence of candidate words, which is different than the previously-determined first candidate word “hello”, computing device 202 may update user interface 1114B by outputting user interface 1114C, which corresponds to user interface 1114B, and which includes text input field 1116C and text input interface 1118C that includes word input fields 1120, to present the candidate word “how” in the portion of user interface 1114C that corresponds to first word input field 1120A in place of the previously-determined candidate word “hello”. Computing device 202 may also present the candidate word “are” in the portion of user interface 11140 that corresponds to second word input field 1120B. In some examples, computing device 202 may also input candidate words “how are” into text input field 1116C in place of the previously-determined candidate word “how”.

After the user has written the character “a” in second word input field 1120B, the user may interact with UID 204 to provide handwriting input that includes handwritten character “y” at a location of user interface 1114C that corresponds to third word input field 1120C in order to input the word abbreviation for a third word in a sequence of words. Because the user had previously inputted the character “h” in first word input field 1120A and the character “a” in second word input field 1120B, the sequence of word abbreviations is now “h”, “a”, and “y”.

In response, computing device 202 may use language model 208 to determine a sequence of candidate words that correspond to the sequence of word abbreviations “h”, “a”, and “y” inputted within the portion of user interface 1114C. For example, computing device 202 may use language model 208 to determine a candidate word “how are you” corresponds to the sequence of word abbreviation “h”, “a”, and “y”.

Computing device 202 may, in response to determining the sequence of candidate words, output the candidate word for display at UID 204. For example, because the computing device has determined that the first and second candidate words “how” and “you” are unchanged from the previously determined sequence of candidate words, computing device 202 may update user interface 1114C by outputting user interface 1114D, which corresponds to user interface 1114C, and which includes text input field 1116D and text input interface 1118D that includes word input fields 1120, that continues to present the candidate words “how” and “are” in first word input field 1120A and second word input field 1120B, respectively, and that may present the candidate word “you” in the portion of user interface 1114D that corresponds to third word input field 1120C. In some examples, computing device 202 may also input candidate words “how are you” into text input field 1116D in place of the previously-determined candidate word “how are”.

The user interfaces 1114A-1114D (“user interfaces 1114”) that includes the sequence of word input fields 1120 may provide several technical advantages for handwritten input of word abbreviations. First, the sequence of word input fields 1120 may allow users to more easily enter candidate words by defining portions of user interface 1114A that are associated with each candidate word, thereby providing visual signals that define portions of user interfaces 1114A in which users may provide further handwriting input to edit specific candidate words in the sequence of candidate words. Further, because handwriting recognizers may typically be trained to recognize whole words rather than word abbreviations, some handwriting recognizers may not be able to accurately recognize that groups of handwritten characters should be grouped as word abbreviations, even when different groups of handwritten characters are spaced apart from each other. By providing word input fields 1120 that define portions of user interface 1114A as being associated with specific word positions in a sequence of words, word input fields 1120 in user interface 1114A may improve the accuracy of handwriting recognizers (e.g., handwriting module 210) in grouping sequences of characters as word abbreviations.

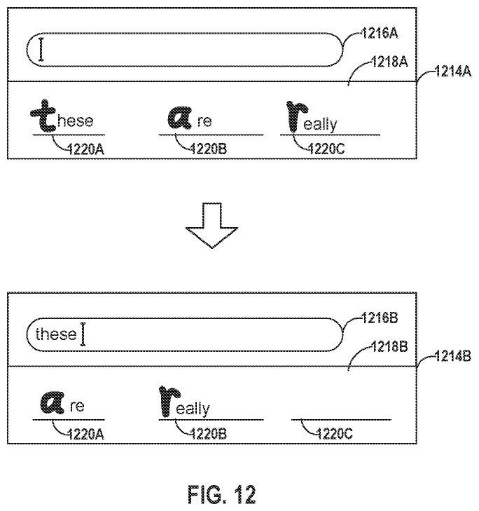

FIG. 12 is a conceptual diagram illustrating an example user interface for determining a sequence of candidate words, in accordance with aspects of the present disclosure. For purposes of illustration only, FIG. 12 is described herein within the context of computing device 202 of FIG. 2.

As shown in FIG. 12, UID 204 of computing device 202 may display user interface 1214A that includes text input field 1216A and text input interface 1218A.

Text input interface 1218A may be a portion of user interface 1214A within which the user may interact to provide handwriting input to input text that may be inserted into text input field 1216A.

Similar to the technique illustrated in FIG. 11, Text input interface 1218A may include a sequence of word input fields 1220A-1220C (“word input fields 1220”). While text input interface 1218A includes five word input fields 1220, text input interface 1218A may, in other examples, include a sequence of any number of word input fields. Each word input field of word input fields 1220 may denote a respective non-overlapping portion of user interface 1214A within which the user of computing device 202 may provide handwritten input of one or more characters.

Word input fields 1220 may be in an ordered sequence according to the writing direction of the language of the handwritten input. In the example of FIG. 12 where UID 204 receives handwritten input in the English language having a left-to-right writing direction, the sequence of word input fields 1220 may be presented in an ordered horizontal direction in user interface 1214A from left to right.

The order of the sequence of word input fields 1220 may correspond to the order of a sequence of words, such that each world input field corresponds to a respective word position in a sequence of words. For example, the first word input field 1220A in the sequence of word input fields 1220 may correspond to the sequentially first word in the sequence of words, the second word input field 1220B in the sequence of word input fields 1220 may correspond to the sequentially second word in the sequence of words, and the third word input field 1220C in the sequence of word input fields 1220 may correspond to the sequentially third word in the sequence of words.

In the example of FIG. 12, the user interacts with UID 204 to provide handwriting input that includes the handwritten character “t” in first word input field 1220A, the handwritten character “a” in second word input field 1220B, and the handwritten character “r” in third word input field 1220C as word abbreviations. Computing device 202 may, in response determine, using language model 208, that the sequence of candidate words “these are really” corresponds to the sequence of word abbreviations “t”, “a”, and “r”, and may present the first candidate word “these” in first word input field 1220A, the second candidate word “are” in second word input field 1220B, and the third candidate word “really” in third word input field 1220B.

As can be seen, when user interface 1214A presents the three candidate words “these”, “are”, and “really” in respective word input fields 1220A-1220C, every one of word input fields 1220 now includes a candidate word, and that there is not another empty word input field for inputting an additional word abbreviation. Computing device 202 may, in response to determining that each word input field of word input fields 1220 includes a candidate word in the sequence of candidate words, commit the initial candidate word in the sequence of candidate words as a committed word in a sequence of words and remove the initial candidate word from the sequence of candidate words, and shift the remaining candidate words in the sequence of candidate words to a new word input field.

In the example of FIG. 12, computing device 202 may commit the initial candidate word “these” so that the sequence of candidate words is changed to “are really”. Because the word “these” is no longer part of the sequence of candidate words, computing device 202 may remove the word “these” from first word input field 1220A.

Further, because the sequence of candidate words after removing the word “these” is now “are really”, the word “are” is now the initial word in the sequence of candidate words “are really”, and “really” is now the second word in the sequence of candidate words “are really”. As such, Computing device 202 may move the word “are” to first word input field 1220A and may move the word “really” to second word input field 1220B.

Computing device 202 may therefore output user interface 1214B, which corresponds to user interface 1214A, and which includes text input field 1216B and text input interface 1218B that includes word input fields 1220, so that the word “these” is removed from first word input field 1220A. Instead, user interface 1214B may present the first word “are” in the resulting sequence of candidate words “are really” in first word input field 1220A, and may present the word “really” in the resulting sequence of candidate words “are really” in second word input field 1220B, thereby leaving an empty third word input field 1220C at which the user may provide a third candidate word to the sequence of candidate words “are really”. In some examples, computing device 202 may also input the committed word “these” into text input field 1216B.

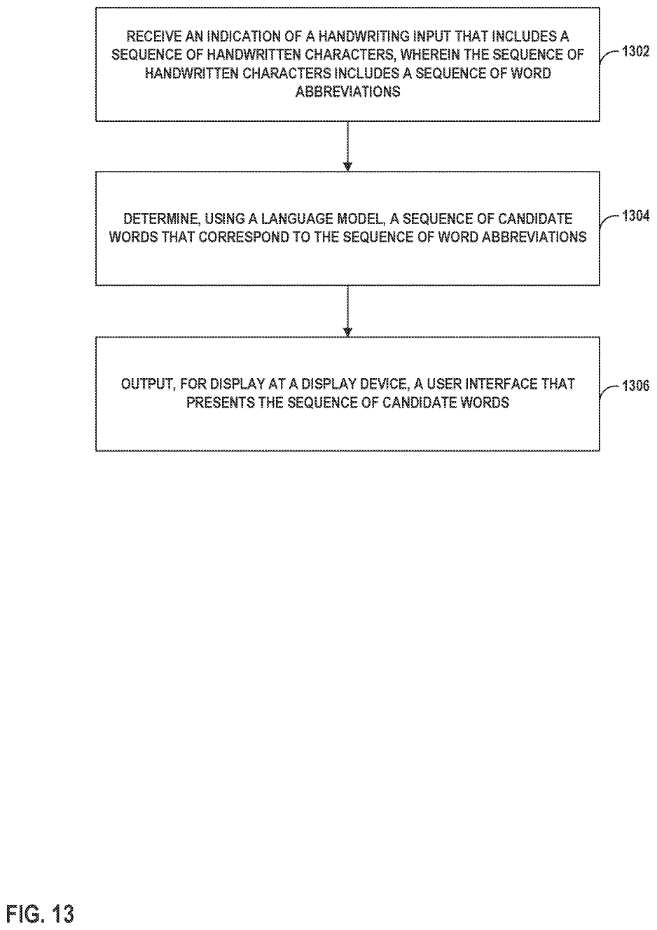

FIG. 13 is a flowchart illustrating example operations of an example computing device having an abbreviated handwriting functionality, in accordance with one or more aspects of the present disclosure. For purposes of illustration only, the example operations are described below within the context of computing device 202 of FIG. 2.

As shown in FIG. 13, one or more processors 240 of computing device 202 may receive an indication of a handwriting input that includes a sequence of handwritten characters, wherein the sequence of handwritten characters includes a sequence of word abbreviations (1302). For example, a user of computing device 202 may interact with UID 204 to provide handwriting input to handwrite a sequence of word abbreviations that correspond to an intended sequence of words, and UID 204 may receive, from UID 204, an indication of the handwriting input.

One or more processors 240 may determine, using a language model 208, a sequence of candidate words that correspond to the sequence of word abbreviations (1304). The language model 208 may be a mathematical model, in the form of one or more neural networks, trained on a large corpus of text via machine learning, that uses probabilistic techniques to determine, given a sequence of word abbreviations, a sequence of words most likely to be the intended sequence of words out of multiple sequences of words that each correspond to the sequence of word abbreviations.

One or more processors 240 may output, for display at a user interface device 204, a user interface that presents the sequence of candidate words (1306). For example, one or more processors 240 may update the user interface to present each candidate words in the form one or more handwritten characters included in the handwriting input and any remaining characters in the candidate word in non-handwritten form.

In some examples, to determine the sequence of candidate words that correspond to the sequence of word abbreviations, the one or more processors 240 may determine, using language model 208, the sequence of candidate words having a sequence of initial characters that corresponds to a sequence of initial characters in the sequence of word abbreviations. In some examples, the sequence of word abbreviations includes a plurality of word abbreviations that are each a sequence of two or more characters, and to determine the sequence of candidate words that correspond to the sequence of word abbreviations, the one or more processors 240 are further configured to determine, using the language model 208, the sequence of candidate words each having a subsequence of characters that matches a corresponding word abbreviation from the sequence of word abbreviations. In some examples, medial characters and final characters in each of the plurality of word abbreviations include only consonants.

In some examples, the one or more processors 240 are further configured to determine, based at least in part on one or more distances between locations in the user interface of two or more handwritten characters from the sequence of handwritten characters, the sequence of word abbreviations from the sequence of characters.

In some examples, the user interface includes a sequence of word input fields, and to receive the indication of handwriting input, the one or more processors 240 are further configured to receive an indication of a first sequence of one or more handwritten characters from the sequence of handwritten characters, wherein a location of the first sequence of one or more handwritten characters in the user interface corresponds to a first portion of the user interface associated with a first word input field from the sequence of word input fields, in response to receiving the indication of the first sequence of one or more handwritten characters, determine the first sequence of one or more handwritten characters and determining, based on the first sequence of one or more handwritten characters, a first word abbreviation in the sequence of word abbreviations, after receiving the indication of the first sequence of one or more handwritten characters, receive an indication of a second sequence of one or more handwritten characters from the sequence of handwritten characters, wherein a location of the second sequence of one or more handwritten characters in the user interface corresponds to a second portion of the user interface associated with a second word input field from the sequence of word input fields, and in response to receiving the indication of the second sequence of one or more handwritten characters, determine, based on the second sequence of one or more handwritten characters, a second word abbreviation in the sequence of word abbreviations.

In some examples, to determine the sequence of candidate words that correspond to the sequence of word abbreviations, the one or more processors 240 are further configured to determine, using the language model 208, the sequence of candidate words that includes a first candidate word corresponding to the first word abbreviation and a second candidate word corresponding to the second word abbreviation, present the first candidate word in the first portion of the user interface associated with the first word input field, and present the second candidate word in the second portion of the user interface associated with the second word input field.

In some examples, the one or more processors 240 are further configured to determine that each portion of the user interface associated with a respective word input field in the sequence of word input fields includes a respective candidate word in the sequence of candidate words, and in response to determining that each portion of the user interface associated with the respective word input field in the sequence of word input fields includes the respective candidate word in the sequence of candidate words, commit an initial candidate word in the sequence of candidate words as a committed word in a sequence of words, remove the initial candidate word from the sequence of candidate words, and in response to removing the initial candidate word from the sequence of candidate words, update the user interface to present the sequence of candidate words.

In some examples, to, for display at the display device 204, the user interface that includes the sequence of candidate words, the one or more processors 240 are further configured to present each respective candidate word in the sequence of candidate words presented in the user interface, including presenting, for the respective candidate word, a respective one or more characters that correspond to one or more handwritten characters from the sequence of handwritten characters as the corresponding one or more handwritten characters, and presenting, in the user interface, any characters in the respective candidate word that do not correspond to any handwritten character from the sequence of handwritten characters as non-handwritten characters.

In some examples, the one or more processors 240 are further configured to receive an indication of second handwriting input that corresponds to a first character, wherein a location of the second handwriting input in the user interface corresponds to a first candidate word in the sequence of candidate words, and wherein the first candidate word includes at least one character that correspond to a handwritten character from the sequence of handwritten characters, combine the at least one character in the first candidate word and the first character corresponding to the second handwriting input as a sequence of characters, replace a word abbreviation that corresponds to the first candidate word from the sequence of word abbreviations with the sequence of characters to determine a second sequence of word abbreviations, determine, using the language model 208, a second sequence of candidate words that correspond to the second sequence of word abbreviations, and update the user interface to present the second sequence of candidate words.

In some examples, the one or more processors 240 are further configured to receive an indication of third handwriting input that corresponds to a second character, wherein a location of the third handwriting input in the user interface corresponds to an initial character of a second candidate word in the sequence of candidate words, based on the location of the third handwriting input in the user interface corresponding to the initial character of the second candidate word, replace an initial character of a word abbreviation that corresponds to the second candidate word from the sequence of word abbreviations with the second character to generate a third sequence of word abbreviations, determine, using the language model 208, a third sequence of candidate words that correspond to the third sequence of word abbreviations, and output, for display at the display device 204, the third sequence of candidate words.

In some examples, one or more processors 240 are further configured to, after receiving the indication of the handwriting input, receive an indication of a fourth handwriting input that corresponds to a punctuation mark, in response to receiving the indication of the fourth handwriting input, determining, by the one or more processors using the language model 208 and based at least in part on the punctuation mark, a fourth sequence of candidate words that corresponds to the sequence of word abbreviations, and output, for display at the display device 204, the fourth sequence of candidate words.

In some examples, the one or more processors 240 are further configured to receive user input that corresponds to selection of a plurality of candidate words from the sequence of candidate words, in response to receiving the user input, receive an indication of a fifth handwriting input that corresponds to one or more characters, wherein a location of the fifth handwriting input in the user interface corresponds to the selected plurality of candidate words, in response to receiving the indication of the fifth handwriting input, replace a plurality of word abbreviations from the sequence of word abbreviations that corresponds to the selected plurality of candidate words with a new word abbreviation that is the one or more characters to generate a fourth sequence of word abbreviations, and determine, using the language model 208, a fifth sequence of candidate words that correspond to the fourth sequence of word abbreviations.

In some examples, the one or more processors 240 are further configured to receive a second user input that corresponds to selection of a third candidate word from the sequence of candidate words, in response to receiving the second user input, determine, using the language model 208, one or more suggested replacement words for replacing the third candidate word from the sequence of candidate words, present the one or more suggested replacement words in the user interface, and in response to receiving a third user input that corresponds to selection of a suggested replacement word from the one or more suggested replacement words, replace the third candidate word in the sequence of candidate words with the selected replacement word.

This disclosure includes the following examples:

Example 1. A method comprising: receiving an indication of a handwriting input that includes a sequence of handwritten characters, wherein the handwriting input corresponds to a sequence of word abbreviations, and wherein each word abbreviation is a sequence of one or more characters; determining, using a language model, a sequence of candidate words that correspond to the sequence of word abbreviations; and outputting, for display at a display device, a user interface that presents the sequence of candidate words.

Example 2. The method of example 1, wherein determining the sequence of candidate words that correspond to the sequence of word abbreviations further comprises: determining, using the language model, a sequence of candidate words having a sequence of initial characters that corresponds to a sequence of initial characters in the sequence of word abbreviations.

Example 3. The method of any of examples 1 and 2, wherein the sequence of word abbreviations includes a plurality of word abbreviations that are each a sequence of two or more characters, and wherein determining the sequence of candidate words that correspond to the sequence of word abbreviations further comprises: determining, using the language model, the sequence of candidate words each having a subsequence of characters that matches a corresponding word abbreviation from the sequence of word abbreviations.

Example 4. The method of example 3, wherein medial characters and final characters in each of the plurality of word abbreviations include only consonants.

Example 5. The method of any of examples 1-4, further comprising: determining, based at least in part on one or more distances between locations in the user interface of two or more handwritten characters from the sequence of handwritten characters, the sequence of word abbreviations from the sequence of characters.

Example 6. The method of any of examples 1-4, wherein the user interface includes a sequence of word input fields, wherein receiving the indication of handwriting input further comprises: receiving an indication of a first sequence of one or more handwritten characters from the sequence of handwritten characters, wherein a location of the first sequence of one or more handwritten characters in the user interface corresponds to a first portion of the user interface associated with a first word input field from the sequence of word input fields; in response to receiving the indication of the first sequence of one or more handwritten characters, determining the first sequence of one or more handwritten characters, and determining, based on the first sequence of one or more handwritten characters, a first word abbreviation in the sequence of word abbreviations; after receiving the indication of the first sequence of one or more handwritten characters, receiving an indication of a second sequence of one or more handwritten characters from the sequence of handwritten characters, wherein a location of the second sequence of one or more handwritten characters in the user interface corresponds to a second portion of the user interface associated with a second word input field from the sequence of word input fields; and in response to receiving the indication of the second sequence of one or more handwritten characters, determining, based on the second sequence of one or more handwritten characters, a second word abbreviation in the sequence of word abbreviations.

Example 7. The method of example 6, wherein determining the sequence of candidate words that correspond to the sequence of word abbreviations further comprises: determining, using the language model, the sequence of candidate words that includes a first candidate word corresponding to the first word abbreviation and a second candidate word corresponding to the second word abbreviation; presenting the first candidate word in the first portion of the user interface associated with the first word input field; and presenting the second candidate word in the second portion of the user interface associated with the second word input field.

Example 8. The method of example 7, further comprising: determining that each portion of the user interface associated with a respective word input field in the sequence of word input fields includes a respective candidate word in the sequence of candidate words; and in response to determining that each portion of the user interface associated with the respective word input field in the sequence of word input fields includes the respective candidate word in the sequence of candidate words, committing an initial candidate word in the sequence of candidate words as a committed word in a sequence of words, removing the initial candidate word from the sequence of candidate words, and in response to removing the initial candidate word from the sequence of candidate words, updating the user interface to present the sequence of candidate words.

Example 9. The method of any of examples 1-8, wherein outputting, for display at the display device, the user interface that includes the sequence of candidate words further comprises: presenting each respective candidate word in the sequence of candidate words presented in the user interface, including presenting, for the respective candidate word, a respective one or more characters that correspond to one or more handwritten characters from the sequence of handwritten characters as the corresponding one or more handwritten characters, and presenting, in the user interface, any characters in the respective candidate word that do not correspond to any handwritten character from the sequence of handwritten characters as non-handwritten characters.

Example 10. The method of example 9, further comprising: receiving an indication of second handwriting input that corresponds to a first character, wherein a location of the second handwriting input in the user interface corresponds to a first candidate word in the sequence of candidate words, and wherein the first candidate word includes at least one character that correspond to a handwritten character from the sequence of handwritten characters; combining the at least one character in the first candidate word and the first character corresponding to the second handwriting input as a sequence of characters; replacing a word abbreviation that corresponds to the first candidate word from the sequence of word abbreviations with the sequence of characters to determine a second sequence of word abbreviations; determining, using the language model, a second sequence of candidate words that correspond to the second sequence of word abbreviations; and updating the user interface to present the second sequence of candidate words.

Example 11. The method of any of examples 9 and 10, further comprising: receiving an indication of third handwriting input that corresponds to a second character, wherein a location of the third handwriting input in the user interface corresponds to an initial character of a second candidate word in the sequence of candidate words; based on the location of the third handwriting input in the user interface corresponding to the initial character of the second candidate word, replacing an initial character of a word abbreviation that corresponds to the second candidate word from the sequence of word abbreviations with the second character to generate a third sequence of word abbreviations; determining, using the language model, a third sequence of candidate words that correspond to the third sequence of word abbreviations; and outputting, for display at the display device, the third sequence of candidate words.

Example 12. The method of any of examples 9-11, further comprising: after receiving the indication of the handwriting input, receiving an indication of a fourth handwriting input that corresponds to a punctuation mark; in response to receiving the indication of the fourth handwriting input, determining, using the language model and based at least in part on the punctuation mark, a fourth sequence of candidate words that corresponds to the sequence of word abbreviations; and outputting, for display at the display device, the fourth sequence of candidate words.

Example 13. The method of any of examples 1-12, further comprising: receiving user input that corresponds to selection of a plurality of candidate words from the sequence of candidate words; in response to receiving the user input, receiving an indication of a fifth handwriting input that corresponds to one or more characters, wherein a location of the fifth handwriting input in the user interface corresponds to the selected plurality of candidate words; in response to receiving the indication of the fifth handwriting input, replacing a plurality of word abbreviations from the sequence of word abbreviations that corresponds to the selected plurality of candidate words with a new word abbreviation that is the one or more characters to generate a fourth sequence of word abbreviations; and determining, using the language model, a fifth sequence of candidate words that correspond to the fourth sequence of word abbreviations.

Example 14. The method of any of examples 1-13, further comprising: receiving a second user input that corresponds to selection of a third candidate word from the sequence of candidate words; in response to receiving the second user input, determining, by the one or more processors using the language model, one or more suggested replacement words for replacing the third candidate word from the sequence of candidate words; presenting the one or more suggested replacement words in the user interface; and in response to receiving a third user input that corresponds to selection of a suggested replacement word from the one or more suggested replacement words, replacing the third candidate word in the sequence of candidate words with the selected replacement word.

Example 15. A computing device comprising: a memory that stores instructions; and one or more processors that execute the instructions to: receive an indication of a handwriting input that includes a sequence of handwritten characters, wherein the sequence of handwritten characters includes a sequence of word abbreviations; determine, using a language model, a sequence of candidate words that correspond to the sequence of word abbreviations; and output, for display at a display device, a user interface that presents the sequence of candidate words.

Example 16. The computing device of example 15, wherein to determine the sequence of candidate words that correspond to the sequence of word abbreviations further comprises: determine, using the language model, a sequence of candidate words having a sequence of initial characters that corresponds to a sequence of initial characters in the sequence of word abbreviations.

Example 17. The computing device of example 15 and 16, wherein the sequence of word abbreviations includes a plurality of word abbreviations that are each a sequence of two or more characters, and wherein to determine the sequence of candidate words that correspond to the sequence of word abbreviations, the one or more processors are further configured to: determine, using the language model, the sequence of candidate words each having a subsequence of characters that matches a corresponding word abbreviation from the sequence of word abbreviations.

Example 18. The computing device of example 17, wherein medial characters and final characters in each of the plurality of word abbreviations include only consonants.

Example 19. The computing device of example 15-18, wherein the one or more processors are further configured to: determine, based at least in part on one or more distances between locations in the user interface of two or more handwritten characters from the sequence of handwritten characters, the sequence of word abbreviations from the sequence of characters.

Example 20. The computing device of example 15-18, wherein to output, for display at the display device, the user interface that includes the sequence of candidate words, the one or more processors are further configured to: present each respective candidate word in the sequence of candidate words presented in the user interface, including presenting, for the respective candidate word, a respective one or more characters that correspond to one or more handwritten characters from the sequence of handwritten characters as the corresponding one or more handwritten characters, and presenting, in the user interface, any characters in the respective candidate word that do not correspond to any handwritten character from the sequence of handwritten characters as non-handwritten characters.

Example 21. The computing device of example 20, wherein the one or more processors are further configured to: receive an indication of second handwriting input that corresponds to a first character, wherein a location of the second handwriting input in the user interface corresponds to a first candidate word in the sequence of candidate words, and wherein the first candidate word includes at least one character that correspond to a handwritten character from the sequence of handwritten characters; combine the at least one character in the first candidate word and the first character corresponding to the second handwriting input as a sequence of characters; replace a word abbreviation that corresponds to the first candidate word from the sequence of word abbreviations with the sequence of characters to determine a second sequence of word abbreviations; determine, using the language model, a second sequence of candidate words that correspond to the second sequence of word abbreviations; and update the user interface to present the second sequence of candidate words.

Example 22. The computing device of example 20 and 21, wherein the one or more processors are further configured to: receive an indication of third handwriting input that corresponds to a second character, wherein a location of the third handwriting input in the user interface corresponds to an initial character of a second candidate word in the sequence of candidate words; based on the location of the third handwriting input in the user interface corresponding to the initial character of the second candidate word, replacing an initial character of a word abbreviation that corresponds to the second candidate word from the sequence of word abbreviations with the second character to generate a third sequence of word abbreviations; determine, using the language model, a third sequence of candidate words that correspond to the third sequence of word abbreviations; and output, for display at the display device, the third sequence of candidate words.

Example 23. The computing device of example 20-22, wherein the one or more processors are further configured to: after receiving the indication of the handwriting input, receive an indication of a fourth handwriting input that corresponds to a punctuation mark; in response to receiving the indication of the fourth handwriting input, determining, using the language model and based at least in part on the punctuation mark, a fourth sequence of candidate words that corresponds to the sequence of word abbreviations; and output, for display at the display device, the fourth sequence of candidate words.

Example 24. The computing device of example 15-23, wherein the one or more processors are further configured to: receive user input that corresponds to selection of a plurality of candidate words from the sequence of candidate words; in response to receiving the user input, receive an indication of a fifth handwriting input that corresponds to one or more characters, wherein a location of the fifth handwriting input in the user interface corresponds to the selected plurality of candidate words; in response to receiving the indication of the fifth handwriting input, replacing a plurality of word abbreviations from the sequence of word abbreviations that corresponds to the selected plurality of candidate words with a new word abbreviation that is the one or more characters to generate a fourth sequence of word abbreviations; and determine, using the language model, a fifth sequence of candidate words that correspond to the fourth sequence of word abbreviations.

Example 25. The computing device of example 15-24, wherein the one or more processors are further configured to: receive a second user input that corresponds to selection of a third candidate word from the sequence of candidate words; in response to receiving the second user input, determine, by the one or more processors using the language model, one or more suggested replacement words for replacing the third candidate word from the sequence of candidate words; present the one or more suggested replacement words in the user interface; and in response to receiving a third user input that corresponds to selection of a suggested replacement word from the one or more suggested replacement words, replace the third candidate word in the sequence of candidate words with the selected replacement word.

Example 26. The computing device of example 15-18, wherein the user interface includes a sequence of word input fields, wherein to receive the indication of handwriting input, the one or more processors are further configured to: receive an indication of a first sequence of one or more handwritten characters from the sequence of handwritten characters, wherein a location of the first sequence of one or more handwritten characters in the user interface corresponds to a first portion of the user interface associated with a first word input field from the sequence of word input fields; in response to receiving the indication of the first sequence of one or more handwritten characters, determine the first sequence of one or more handwritten characters, and determining, based on the first sequence of one or more handwritten characters, a first word abbreviation in the sequence of word abbreviations; after receiving the indication of the first sequence of one or more handwritten characters, receive an indication of a second sequence of one or more handwritten characters from the sequence of handwritten characters, wherein a location of the second sequence of one or more handwritten characters in the user interface corresponds to a second portion of the user interface associated with a second word input field from the sequence of word input fields; and in response to receiving the indication of the second sequence of one or more handwritten characters, determine, based on the second sequence of one or more handwritten characters, a second word abbreviation in the sequence of word abbreviations.

Example 27. The computing device of example 26, wherein to determine the sequence of candidate words that correspond to the sequence of word abbreviations, the one or more processors are further configured to: determine, using the language model, the sequence of candidate words that includes a first candidate word corresponding to the first word abbreviation and a second candidate word corresponding to the second word abbreviation; present the first candidate word in the first portion of the user interface associated with the first word input field; and present the second candidate word in the second portion of the user interface associated with the second word input field.

Example 28. The computing device of example 27, wherein the one or more processors are further configured to: determine that each portion of the user interface associated with a respective word input field in the sequence of word input fields includes a respective candidate word in the sequence of candidate words; and in response to determining that each portion of the user interface associated with the respective word input field in the sequence of word input fields includes the respective candidate word in the sequence of candidate words, commit an initial candidate word in the sequence of candidate words as a committed word in a sequence of words, remove the initial candidate word from the sequence of candidate words, and in response to removing the initial candidate word from the sequence of candidate words, update the user interface to present the sequence of candidate words.

Example 29. An apparatus comprising: means for receiving an indication of a handwriting input that includes a sequence of handwritten characters, wherein the sequence of handwritten characters includes a sequence of word abbreviations; means for determining, using a language model, a sequence of candidate words that correspond to the sequence of word abbreviations; and means for outputting, for display at a display device, a user interface that presents the sequence of candidate words.

Example 30. The apparatus of example 29, wherein means for determining the sequence of candidate words that correspond to the sequence of word abbreviations further comprises: means for determining, using the language model, a sequence of candidate words having a sequence of initial characters that corresponds to a sequence of initial characters in the sequence of word abbreviations.

Example 31. The apparatus of any of examples 29 and 30, wherein the sequence of word abbreviations includes a plurality of word abbreviations that are each a sequence of two or more characters, and wherein the means for determining the sequence of candidate words that correspond to the sequence of word abbreviations further comprises: means for determining, using the language model, the sequence of candidate words each having a subsequence of characters that matches a corresponding word abbreviation from the sequence of word abbreviations.

Example 32. The apparatus of example 31, wherein medial characters and final characters in each of the plurality of word abbreviations include only consonants.

Example 33. The apparatus of any of examples 29-32, further comprising: means for determining, based at least in part on one or more distances between locations in the user interface of two or more handwritten characters from the sequence of handwritten characters, the sequence of word abbreviations from the sequence of characters.

Example 34. The apparatus of any of examples 29-32, wherein the user interface includes a sequence of word input fields, wherein the means for receiving the indication of handwriting input further comprises: means for receiving an indication of a first sequence of one or more handwritten characters from the sequence of handwritten characters, wherein a location of the first sequence of one or more handwritten characters in the user interface corresponds to a first portion of the user interface associated with a first word input field from the sequence of word input fields; means for, in response to receiving the indication of the first sequence of one or more handwritten characters, determining the first sequence of one or more handwritten characters, and determining, based on the first sequence of one or more handwritten characters, a first word abbreviation in the sequence of word abbreviations; means for, after receiving the indication of the first sequence of one or more handwritten characters, receiving an indication of a second sequence of one or more handwritten characters from the sequence of handwritten characters, wherein a location of the second sequence of one or more handwritten characters in the user interface corresponds to a second portion of the user interface associated with a second word input field from the sequence of word input fields; and means for, in response to receiving the indication of the second sequence of one or more handwritten characters, determining, based on the second sequence of one or more handwritten characters, a second word abbreviation in the sequence of word abbreviations.

Example 35. The apparatus of example 34, wherein the means for determining the sequence of candidate words that correspond to the sequence of word abbreviations further comprises: means for determining, using the language model, the sequence of candidate words that includes a first candidate word corresponding to the first word abbreviation and a second candidate word corresponding to the second word abbreviation; means for presenting the first candidate word in the first portion of the user interface associated with the first word input field; and means for presenting the second candidate word in the second portion of the user interface associated with the second word input field.

Example 36. The apparatus of example 35, further comprising: means for determining that each portion of the user interface associated with a respective word input field in the sequence of word input fields includes a respective candidate word in the sequence of candidate words; and means for, in response to determining that each portion of the user interface associated with the respective word input field in the sequence of word input fields includes the respective candidate word in the sequence of candidate words, committing an initial candidate word in the sequence of candidate words as a committed word in a sequence of words, removing the initial candidate word from the sequence of candidate words, and in response to removing the initial candidate word from the sequence of candidate words, updating the user interface to present the sequence of candidate words.

Example 37. The apparatus of any of examples 29-36, wherein the means for outputting, for display at the display device, the user interface that includes the sequence of candidate words further comprises: means for presenting each respective candidate word in the sequence of candidate words presented in the user interface, including means for presenting, for the respective candidate word, a respective one or more characters that correspond to one or more handwritten characters from the sequence of handwritten characters as the corresponding one or more handwritten characters, and means for presenting, in the user interface, any characters in the respective candidate word that do not correspond to any handwritten character from the sequence of handwritten characters as non-handwritten characters.

Example 38. The apparatus of example 37, further comprising: means for receiving an indication of second handwriting input that corresponds to a first character, wherein a location of the second handwriting input in the user interface corresponds to a first candidate word in the sequence of candidate words, and wherein the first candidate word includes at least one character that correspond to a handwritten character from the sequence of handwritten characters; means for combining the at least one character in the first candidate word and the first character corresponding to the second handwriting input as a sequence of characters; means for replacing a word abbreviation that corresponds to the first candidate word from the sequence of word abbreviations with the sequence of characters to determine a second sequence of word abbreviations; means for determining, using the language model, a second sequence of candidate words that correspond to the second sequence of word abbreviations; and means for updating the user interface to present the second sequence of candidate words.

Example 39. The apparatus of any of examples 37 and 38, further comprising: means for receiving an indication of third handwriting input that corresponds to a second character, wherein a location of the third handwriting input in the user interface corresponds to an initial character of a second candidate word in the sequence of candidate words; means for, based on the location of the third handwriting input in the user interface corresponding to the initial character of the second candidate word, replacing an initial character of a word abbreviation that corresponds to the second candidate word from the sequence of word abbreviations with the second character to generate a third sequence of word abbreviations; means for determining, using the language model, a third sequence of candidate words that correspond to the third sequence of word abbreviations; and means for outputting, for display at the display device, the third sequence of candidate words.

Example 40. The apparatus of any of examples 37-39, further comprising: means for, after receiving the indication of the handwriting input, receiving an indication of a fourth handwriting input that corresponds to a punctuation mark; means for, in response to receiving the indication of the fourth handwriting input, determining, using the language model and based at least in part on the punctuation mark, a fourth sequence of candidate words that corresponds to the sequence of word abbreviations; and means for outputting, for display at the display device, the fourth sequence of candidate words.

Example 41. The apparatus of any of examples 29-40, further comprising: means for receiving user input that corresponds to selection of a plurality of candidate words from the sequence of candidate words; means for, in response to receiving the user input, receiving an indication of a fifth handwriting input that corresponds to one or more characters, wherein a location of the fifth handwriting input in the user interface corresponds to the selected plurality of candidate words; means for, in response to receiving the indication of the fifth handwriting input, replacing a plurality of word abbreviations from the sequence of word abbreviations that corresponds to the selected plurality of candidate words with a new word abbreviation that is the one or more characters to generate a fourth sequence of word abbreviations; and means for determining, using the language model, a fifth sequence of candidate words that correspond to the fourth sequence of word abbreviations.

Example 42. The apparatus of any of examples 29-41, further comprising: means for receiving a second user input that corresponds to selection of a third candidate word from the sequence of candidate words; means for, in response to receiving the second user input, determining, by the one or more processors using the language model, one or more suggested replacement words for replacing the third candidate word from the sequence of candidate words; means for presenting the one or more suggested replacement words in the user interface; and means for, in response to receiving a third user input that corresponds to selection of a suggested replacement word from the one or more suggested replacement words, replacing the third candidate word in the sequence of candidate words with the selected replacement word.

Example 43. A non-transitory computer-readable storage medium storing instructions that, when executed, cause one or more processors of a computing device to: receive an indication of a handwriting input that includes a sequence of handwritten characters, wherein the sequence of handwritten characters includes a sequence of word abbreviations; determine, using a language model, a sequence of candidate words that correspond to the sequence of word abbreviations; and output, for display at a display device, a user interface that presents the sequence of candidate words.

Example 44. The non-transitory computer-readable storage medium of example 43, wherein the instructions that cause the one or more processors to determine the sequence of candidate words that correspond to the sequence of word abbreviations further comprises: determine, using the language model, a sequence of candidate words having a sequence of initial characters that corresponds to a sequence of initial characters in the sequence of word abbreviations.

Example 45. The non-transitory computer-readable storage medium of example 43 and 44, wherein the sequence of word abbreviations includes a plurality of word abbreviations that are each a sequence of two or more characters, and wherein the instructions that cause the one or more processors to determine the sequence of candidate words that correspond to the sequence of word abbreviations further cause the one or more processors to: determine, using the language model, the sequence of candidate words each having a subsequence of characters that matches a corresponding word abbreviation from the sequence of word abbreviations.

Example 46. The non-transitory computer-readable storage medium of example 45, wherein medial characters and final characters in each of the plurality of word abbreviations include only consonants.

Example 47. The non-transitory computer-readable storage medium of example 43-46, wherein the instructions further cause the one or more processors to: determine, based at least in part on one or more distances between locations in the user interface of two or more handwritten characters from the sequence of handwritten characters, the sequence of word abbreviations from the sequence of characters.

Example 48. The non-transitory computer-readable storage medium of example 43-46, wherein the instructions that cause the one or more processors to output, for display at the display device, the user interface that includes the sequence of candidate words further cause the one or more processors to: present each respective candidate word in the sequence of candidate words presented in the user interface, including presenting, for the respective candidate word, a respective one or more characters that correspond to one or more handwritten characters from the sequence of handwritten characters as the corresponding one or more handwritten characters, and presenting, in the user interface, any characters in the respective candidate word that do not correspond to any handwritten character from the sequence of handwritten characters as non-handwritten characters.

Example 49. The non-transitory computer-readable storage medium of example 48, wherein the instructions further cause the one or more processors to: receive an indication of second handwriting input that corresponds to a first character, wherein a location of the second handwriting input in the user interface corresponds to a first candidate word in the sequence of candidate words, and wherein the first candidate word includes at least one character that correspond to a handwritten character from the sequence of handwritten characters; combine the at least one character in the first candidate word and the first character corresponding to the second handwriting input as a sequence of characters; replace a word abbreviation that corresponds to the first candidate word from the sequence of word abbreviations with the sequence of characters to determine a second sequence of word abbreviations; determine, using the language model, a second sequence of candidate words that correspond to the second sequence of word abbreviations; and update the user interface to present the second sequence of candidate words.

Example 50. The non-transitory computer-readable storage medium of example 48 and 49, wherein the instructions further cause the one or more processors to: receive an indication of third handwriting input that corresponds to a second character, wherein a location of the third handwriting input in the user interface corresponds to an initial character of a second candidate word in the sequence of candidate words; based on the location of the third handwriting input in the user interface corresponding to the initial character of the second candidate word, replace an initial character of a word abbreviation that corresponds to the second candidate word from the sequence of word abbreviations with the second character to generate a third sequence of word abbreviations; determine, using the language model, a third sequence of candidate words that correspond to the third sequence of word abbreviations; and output, for display at the display device, the third sequence of candidate words.

Example 51. The non-transitory computer-readable storage medium of example 48-50, wherein the instructions further cause the one or more processors to: after receiving the indication of the handwriting input, receive an indication of a fourth handwriting input that corresponds to a punctuation mark; in response to receiving the indication of the fourth handwriting input, determine, using the language model and based at least in part on the punctuation mark, a fourth sequence of candidate words that corresponds to the sequence of word abbreviations; and output, for display at the display device, the fourth sequence of candidate words.

Example 52. The non-transitory computer-readable storage medium of example 43-51, wherein the instructions further cause the one or more processors to: receive user input that corresponds to selection of a plurality of candidate words from the sequence of candidate words; in response to receiving the user input, receive an indication of a fifth handwriting input that corresponds to one or more characters, wherein a location of the fifth handwriting input in the user interface corresponds to the selected plurality of candidate words; in response to receiving the indication of the fifth handwriting input, replacing a plurality of word abbreviations from the sequence of word abbreviations that corresponds to the selected plurality of candidate words with a new word abbreviation that is the one or more characters to generate a fourth sequence of word abbreviations; and determine, using the language model, a fifth sequence of candidate words that correspond to the fourth sequence of word abbreviations.

Example 53. The non-transitory computer-readable storage medium of example 43-52, wherein the instructions further cause the one or more processors to: receive a second user input that corresponds to selection of a third candidate word from the sequence of candidate words; in response to receiving the second user input, determine, by the one or more processors using the language model, one or more suggested replacement words for replacing the third candidate word from the sequence of candidate words; present the one or more suggested replacement words in the user interface; and in response to receiving a third user input that corresponds to selection of a suggested replacement word from the one or more suggested replacement words, replace the third candidate word in the sequence of candidate words with the selected replacement word.

Example 54. The non-transitory computer-readable storage medium of example 43-53, wherein the user interface includes a sequence of word input fields, wherein the instructions that cause the one or more processors to receive the indication of handwriting input further cause the one or more processors to: receive an indication of a first sequence of one or more handwritten characters from the sequence of handwritten characters, wherein a location of the first sequence of one or more handwritten characters in the user interface corresponds to a first portion of the user interface associated with a first word input field from the sequence of word input fields; in response to receiving the indication of the first sequence of one or more handwritten characters, determine the first sequence of one or more handwritten characters, and determining, based on the first sequence of one or more handwritten characters, a first word abbreviation in the sequence of word abbreviations; after receiving the indication of the first sequence of one or more handwritten characters, receive an indication of a second sequence of one or more handwritten characters from the sequence of handwritten characters, wherein a location of the second sequence of one or more handwritten characters in the user interface corresponds to a second portion of the user interface associated with a second word input field from the sequence of word input fields; and in response to receiving the indication of the second sequence of one or more handwritten characters, determine, based on the second sequence of one or more handwritten characters, a second word abbreviation in the sequence of word abbreviations.

Example 55. The non-transitory computer-readable storage medium of example 54, wherein the instructions that cause the one or more processors to determine the sequence of candidate words that correspond to the sequence of word abbreviations further cause the one or more processors to: determine, using the language model, the sequence of candidate words that includes a first candidate word corresponding to the first word abbreviation and a second candidate word corresponding to the second word abbreviation; present the first candidate word in the first portion of the user interface associated with the first word input field; and present the second candidate word in the second portion of the user interface associated with the second word input field.

Example 56. The non-transitory computer-readable storage medium of example 55, wherein the instructions further cause the one or more processors to: determine that each portion of the user interface associated with a respective word input field in the sequence of word input fields includes a respective candidate word in the sequence of candidate words; and in response to determining that each portion of the user interface associated with the respective word input field in the sequence of word input fields includes the respective candidate word in the sequence of candidate words, commit an initial candidate word in the sequence of candidate words as a committed word in a sequence of words, remove the initial candidate word from the sequence of candidate words, and in response to removing the initial candidate word from the sequence of candidate words, update the user interface to present the sequence of candidate words.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

1. A method comprising:
receiving, by one or more processors, an indication of a handwriting input that includes a sequence of handwritten characters, wherein the sequence of handwritten characters includes a sequence of word abbreviations;
determining, by the one or more processors and using a language model, a sequence of candidate words that correspond to the sequence of word abbreviations; and
outputting, by the one or more processors for display at a display device, a user interface that presents the sequence of candidate words.

2. The method of claim 1, wherein determining the sequence of candidate words that correspond to the sequence of word abbreviations further comprises:
determining, by the one or more processors using the language model, a sequence of candidate words having a sequence of initial characters that corresponds to a sequence of initial characters in the sequence of word abbreviations.

3. The method of claim 1, wherein the sequence of word abbreviations includes a plurality of word abbreviations that are each a sequence of two or more characters, and wherein determining the sequence of candidate words that correspond to the sequence of word abbreviations further comprises:
determining, by the one or more processors using the language model, a sequence of candidate words each having a subsequence of characters that matches a corresponding word abbreviation from the sequence of word abbreviations.

4. The method of claim 3, wherein medial characters and final characters in each of the plurality of word abbreviations include only consonants.

5. The method of claim 1, further comprising:
determining, by the one or more processors and based at least in part on one or more distances between locations in the user interface of two or more handwritten characters from the sequence of handwritten characters, the sequence of word abbreviations from the sequence of characters.

6. The method of claim 1, wherein the user interface includes a sequence of word input fields, wherein receiving the indication of handwriting input further comprises:
receiving an indication of a first sequence of one or more handwritten characters from the sequence of handwritten characters, wherein a location of the first sequence of one or more handwritten characters in the user interface corresponds to a first portion of the user interface associated with a first word input field from the sequence of word input fields;
in response to receiving the indication of the first sequence of one or more handwritten characters, determining, by the one or more processors, the first sequence of one or more handwritten characters, and determining, based on the first sequence of one or more handwritten characters, a first word abbreviation in the sequence of word abbreviations;
after receiving the indication of the first sequence of one or more handwritten characters, receiving, by the one or more processors, an indication of a second sequence of one or more handwritten characters from the sequence of handwritten characters, wherein a location of the second sequence of one or more handwritten characters in the user interface corresponds to a second portion of the user interface associated with a second word input field from the sequence of word input fields; and
in response to receiving the indication of the second sequence of one or more handwritten characters, determining, by the one or more processors and based on the second sequence of one or more handwritten characters, a second word abbreviation in the sequence of word abbreviations.

7. The method of claim 6, wherein determining the sequence of candidate words that correspond to the sequence of word abbreviations further comprises:
determining, by the one or more processors using the language model, the sequence of candidate words that includes a first candidate word corresponding to the first word abbreviation and a second candidate word corresponding to the second word abbreviation;
presenting, by the one or more processors, the first candidate word in the first portion of the user interface associated with the first word input field; and
presenting, by the one or more processors, the second candidate word in the second portion of the user interface associated with the second word input field.

8. The method of claim 7, further comprising:
determining, by the one or more processors, that each portion of the user interface associated with a respective word input field in the sequence of word input fields includes a respective candidate word in the sequence of candidate words; and
in response to determining that each portion of the user interface associated with the respective word input field in the sequence of word input fields includes the respective candidate word in the sequence of candidate words,
committing, by the one or more processors, an initial candidate word in the sequence of candidate words as a committed word in a sequence of words,
removing, by the one or more processors, the initial candidate word from the sequence of candidate words, and
in response to removing the initial candidate word from the sequence of candidate words, updating, by the one or more processors, the user interface to present the sequence of candidate words.

9. The method of claim 1, wherein outputting, for display at the display device, the user interface that includes the sequence of candidate words further comprises:
presenting, by the one or more processors, each respective candidate word in the sequence of candidate words presented in the user interface, including presenting, for the respective candidate word, a respective one or more characters that correspond to one or more handwritten characters from the sequence of handwritten characters as the corresponding one or more handwritten characters, and presenting, in the user interface, any characters in the respective candidate word that do not correspond to any handwritten character from the sequence of handwritten characters as non-handwritten characters.

10. The method of claim 9, further comprising:
receiving, by the one or more processors, an indication of second handwriting input that corresponds to a first character, wherein a location of the second handwriting input in the user interface corresponds to a first candidate word in the sequence of candidate words, and wherein the first candidate word includes at least one character that correspond to a handwritten character from the sequence of handwritten characters;
combining, by the one or more processors, the at least one character in the first candidate word and the first character corresponding to the second handwriting input as a sequence of characters;
replacing, by the one or more processors, a word abbreviation that corresponds to the first candidate word from the sequence of word abbreviations with the sequence of characters to determine a second sequence of word abbreviations;
determining, by the one or more processors using the language model, a second sequence of candidate words that correspond to the second sequence of word abbreviations; and
updating, by the one or more processors, the user interface to present the second sequence of candidate words.

11. The method of claim 1, further comprising:
receiving, by the one or more processors, an indication of third handwriting input that corresponds to a second character, wherein a location of the third handwriting input in the user interface corresponds to an initial character of a second candidate word in the sequence of candidate words;
based on the location of the third handwriting input in the user interface corresponding to the initial character of the second candidate word, replacing, by the one or more processors, an initial character of a word abbreviation that corresponds to the second candidate word from the sequence of word abbreviations with the second character to generate a third sequence of word abbreviations;
determining, by the one or more processors using the language model, a third sequence of candidate words that correspond to the third sequence of word abbreviations; and
outputting, by the one or more processors for display at the display device, the third sequence of candidate words.

12. The method of claim 1, further comprising:
after receiving the indication of the handwriting input, receiving, by the one or more processors, an indication of a fourth handwriting input that corresponds to a punctuation mark;
in response to receiving the indication of the fourth handwriting input, determining, by the one or more processors using the language model and based at least in part on the punctuation mark, a fourth sequence of candidate words that corresponds to the sequence of word abbreviations; and
outputting, by the one or more processors for display at the display device, the fourth sequence of candidate words.

13. The method of claim 1, further comprising:
receiving, by the one or more processors, user input that corresponds to selection of a plurality of candidate words from the sequence of candidate words;
in response to receiving the user input, receiving, by the one or more processors, an indication of a fifth handwriting input that corresponds to one or more characters, wherein a location of the fifth handwriting input in the user interface corresponds to the selected plurality of candidate words;
in response to receiving the indication of the fifth handwriting input, replacing, by the one or more processors, a plurality of word abbreviations from the sequence of word abbreviations that corresponds to the selected plurality of candidate words with a new word abbreviation that is the one or more characters to generate a fourth sequence of word abbreviations; and
determining, by the one or more processors using the language model, a fifth sequence of candidate words that correspond to the fourth sequence of word abbreviations.

14. The method of claim 1, further comprising:
receiving, by the one or more processors, a second user input that corresponds to selection of a third candidate word from the sequence of candidate words;
in response to receiving the second user input, determining, by the one or more processors using the language model, one or more suggested replacement words for replacing the third candidate word from the sequence of candidate words;
presenting, by the one or more processors, the one or more suggested replacement words in the user interface; and
in response to receiving a third user input that corresponds to selection of a suggested replacement word from the one or more suggested replacement words, replacing, by the one or more processors, the third candidate word in the sequence of candidate words with the selected replacement word.

15. A computing device comprising:
a display device;
one or more processors; and
non-transitory computer readable media that stores instructions that, when executed, configure the one or more processors to:
receive an indication of a handwriting input that includes a sequence of handwritten characters, wherein the sequence of handwritten characters includes a sequence of word abbreviations;
determine, using a language model, a sequence of candidate words that correspond to the sequence of word abbreviations; and
output for display at the display device, a user interface that presents the sequence of candidate words.

16. The computing device of claim 15, wherein the one or more processors are further configured to:
determine, using the language model, a sequence of candidate words having a sequence of initial characters that corresponds to a sequence of initial characters in the sequence of word abbreviations.

17. The computing device of claim 15:
wherein the sequence of word abbreviations includes a plurality of word abbreviations that are each a sequence of two or more characters; and
wherein the one or more processors are further configured to:
determine, using the language model, a sequence of candidate words each having a subsequence of characters that matches a corresponding word abbreviation from the sequence of word abbreviations; and
wherein medial characters and final characters in each of the plurality of word abbreviations include only consonants.

18. The computing device of claim 15, wherein the one or more processors are further configured to:
determine, based at least in part on one or more distances between locations in the user interface of two or more handwritten characters from the sequence of handwritten characters, the sequence of word abbreviations from the sequence of characters.

19. A non-transitory computer-readable medium storing instructions that, when executed by one or more processors, cause the one or more processors to perform operations comprising:
receive an indication of a handwriting input that includes a sequence of handwritten characters, wherein the sequence of handwritten characters includes a sequence of word abbreviations;
determine, using a language model, a sequence of candidate words that correspond to the sequence of word abbreviations; and
output for display at a display device, a user interface that presents the sequence of candidate words.

20. The non-transitory computer-readable medium of claim 19, wherein the one or more processors are further configured to:
determine, using the language model, a sequence of candidate words having a sequence of initial characters that corresponds to a sequence of initial characters in the sequence of word abbreviations.
